(19) United States
(12) Patent Application Publication
(10) Pub. No.: US 2025/0207913 A1
(43) Pub. Date: Jun. 26, 2025

(54) SURFACE ROUGHNESS CALCULATION DEVICE

(71) Applicant: SUMITOMO HEAVY INDUSTRIES, LTD., Tokyo (JP)

(72) Inventor: Yoshitaka IGARASHI, Yokosuka-shi (JP)

(21) Appl. No.: 19/075,745

(22) Filed: Mar. 10, 2025

Related U.S. Application Data
(63) Continuation of application No. PCT/JP2023/028558, filed on Aug. 4, 2023.

(30) Foreign Application Priority Data
Oct. 5, 2022 (JP) 2022-160869

(51) Int. Cl. G01B 11/30; G01B 11/25

(52) U.S. Cl. CPC G01B 11/30; G01B 11/254

(57) ABSTRACT

A surface roughness calculation device includes: a scattered light intensity distribution acquisition unit that receives scattered light from a surface of an object and that calculates a first scattered light intensity distribution from a light reception result; and a surface roughness calculation unit that calculates a surface roughness index of the object, in which the surface roughness calculation unit corrects a provisional value of the surface roughness index until a second scattered light intensity distribution obtained by calculation using the provisional value of the surface roughness index and the first scattered light intensity distribution satisfy a first fitting condition, and determines the provisional value of the surface roughness index when the first fitting condition is satisfied as a value of the surface roughness index of the surface of the object.

### CROSS-REFERENCE TO RELATED APPLICATIONS

This is a bypass continuation of International PCT Application No. PCT/JP2023/028558, filed on Aug. 4, 2023, which claims priority to Japanese Patent Application No. 2022-160869, filed on Oct. 5, 2022, which are incorporated by reference herein in their entirety.

### BACKGROUND

### Technical Field

Certain embodiments of the present invention relate to a surface roughness calculation device.

### Description of Related Art

A method of estimating surface attributes of an object using a plenoptic camera (also referred to as a light field camera) is known (the related art). In this method, the object is irradiated with collimated light, and the light field camera acquires a plenoptic image. Surface normals (surface shapes), specular reflection, and surface roughnesses of various regions of the object are calculated based on the plenoptic image.

### SUMMARY

According to an aspect of the present invention, there is provided a surface roughness calculation device including: a scattered light intensity distribution acquisition unit that receives scattered light from a surface of an object and that calculates a first scattered light intensity distribution from a light reception result; and a surface roughness calculation unit that calculates a surface roughness index of the object, in which the surface roughness calculation unit corrects a provisional value of the surface roughness index until a second scattered light intensity distribution obtained by calculation using the provisional value of the surface roughness index and the first scattered light intensity distribution satisfy a first fitting condition, and determines the provisional value of the surface roughness index when the first fitting condition is satisfied as a value of the surface roughness index of the surface of the object.

### BRIEF DESCRIPTION OF THE DRAWINGS

FIG. 1 is a schematic view showing a surface roughness measurement apparatus including a surface roughness calculation device according to one embodiment.

FIG. 2 is a view schematically showing image data generated in each stage when a method of calculating shape information using a spatial coding method is executed.

FIG. 3 is a view schematically showing image data generated in each stage when a method of calculating shape information using a phase shift method is executed.

FIG. 4 is a flowchart showing a procedure of calculating a surface roughness index.

FIG. 5 is a flowchart showing a procedure in Step SA3 shown in FIG. 4.

FIGS. 6A, 6B, and 6C show examples of a first scattered light intensity distribution before noise removal and after noise removal when noise is removed using a Fourier analysis method, a multi-resolution analysis method, and a singular spectrum analysis method, respectively.

FIG. 7 is a graph showing an example of the first scattered light intensity distribution before noise removal, the first scattered light intensity distribution after noise removal, and a second scattered light intensity distribution when a first fitting condition is satisfied.

FIG. 8 is a flowchart showing a method of calculating a root mean square slope Sdq.

FIGS. 9A to 9C are graphs showing relationships between parameters a, b, and c and actually measured values of the root mean square slope Sdq, respectively.

FIG. 10A is a schematic view showing a shape measurement area and a surface roughness measurement area of the object that can be measured by the measurement apparatus according to one embodiment, and FIG. 10B is a schematic view showing a shape measurement area and a surface roughness measurement area of the object that can be measured by a method according to the related art that is generally put into practical use.

FIGS. 11A to 11D are partially perspective views showing four types of samples whose surface roughnesses have been actually measured.

FIGS. 12A to 12D are scatter diagrams showing a relationship between a root mean square roughness Sq measured using a laser microscope equipped with a white light interferometer according to the related art and a root mean square roughness Sq measured using the measurement apparatus according to one embodiment.

FIGS. 13A to 13D are scatter diagrams showing a relationship between the root mean square roughness Sq measured using a contact-type surface roughness meter and the root mean square roughness Sq measured using a non-contact-type measurement device.

FIG. 14 is a schematic view showing a surface roughness measurement apparatus including a surface roughness calculation device according to another embodiment.

FIG. 15 is a schematic front view when a light receiving element and a light receiving element moving mechanism of the surface roughness calculation device according to another embodiment are viewed from a negative side to a positive side of a z-axis.

FIG. 16 is a flowchart showing a procedure in which a surface roughness calculation unit of the surface roughness calculation device according to another embodiment obtains a surface roughness index using calculation.

FIGS. 17A and 17B are scatter diagrams showing a relationship between a measured value of a root mean square roughness Rq obtained by the laser microscope equipped with the white light interferometer according to the related art and a calculated value of the root mean square roughness Rq obtained using the calculation device according to another embodiment.

FIG. 18 is a block diagram showing a function of a root mean square slope estimation unit of the surface roughness calculation device according to another embodiment.

FIGS. 19A and 19B are matrix scatter diagrams showing a measured Rdq value, a calculated Ra value, and a calculated Lc value.

FIG. 20 is a block diagram showing a function of an arithmetic mean roughness estimation unit of the surface roughness calculation device according to another embodiment.

FIGS. 21A and 21B are scatter diagrams showing a relationship between an estimated Ra value calculated by the arithmetic mean roughness estimation unit and a measured Ra value obtained by the laser microscope.

FIG. 22 is a block diagram showing a function of a surface property aspect ratio estimation unit of the surface roughness calculation device according to another embodiment.

FIG. 23 is a scatter diagram showing a relationship between a variable r_min/r_max calculated from a calculated value of the surface correlation length Lc and a measured value of Str.

FIG. 24 is a block diagram showing a function of a glossiness estimation unit of the surface roughness calculation device according to another embodiment.

FIG. 25 is a scatter diagram showing a relationship between a calculated Rq value and a measured glossiness value.

FIG. 26 is a block diagram showing another function of the glossiness estimation unit of the surface roughness calculation device according to another embodiment.

FIG. 27 is a scatter diagram showing a relationship between a calculated Rdq value and the measured glossiness value.

FIGS. 28A and 28B are graphs showing the first scattered light intensity distribution acquired in Step SC1 (FIG. 16).

FIG. 29A is a graph showing the calculated values of Rq obtained when a laser beam is incident on a portion without a scratch, a portion with a relatively small scratch, and a portion with a relatively large scratch in the object in units of [μm], FIG. 29B is a graph obtained by changing a vertical axis of the graph shown in FIG. 29A to the surface correlation length Lc, and FIG. 29C is a graph obtained by changing the vertical axis of the graph shown in FIG. 29A to an integrated value of an autocovariance of the scattered light intensity distribution.

FIG. 30 is a schematic view showing a surface roughness measurement apparatus including a surface roughness calculation device according to further embodiment.

FIG. 31 is a block diagram showing a function of a root mean square slope estimation unit of the surface roughness calculation device according to further embodiment.

FIG. 32 is a block diagram showing a function of an arithmetic mean roughness estimation unit of the surface roughness calculation device according to further embodiment.

FIG. 33 is a block diagram showing a function of a glossiness estimation unit of the surface roughness calculation device according to further embodiment.

FIG. 34 is a block diagram showing another function of the glossiness estimation unit of the surface roughness calculation device according to further embodiment.

### DETAILED DESCRIPTION

In the method according to the related art, a Ward BRDF model is used to calculate the surface roughness. In the Ward BRDF model, it is not possible to handle a scattered light distribution that significantly deviates from reflected light. Further, the wavelength dependence of a surface state is not considered. Therefore, it is difficult to improve the accuracy of calculating a surface roughness index. It is desirable to provide a surface roughness calculation device that can calculate surface roughness without using a Ward BRDF model.

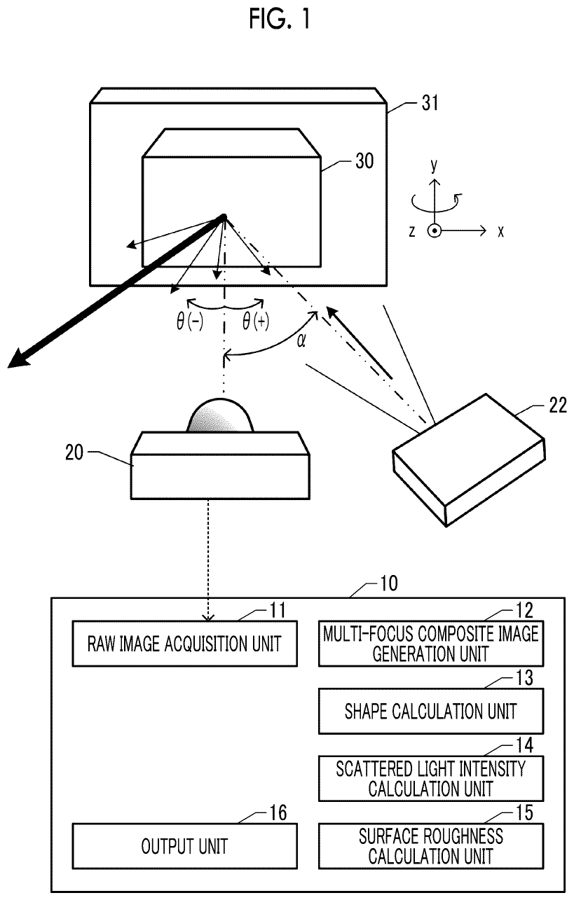

A surface roughness calculation device according to one embodiment will be described with reference to the drawings from FIG. 1 to FIG. 9C.

FIG. 1 is a schematic view showing a surface roughness measurement apparatus including a surface roughness calculation device 10 according to one embodiment. A projector 22 irradiates a surface of an object 30 with measurement light. The object 30 is held by a stage 31. An xyz orthogonal coordinate system is defined in a space in which the object 30 is disposed. The stage 31 can translate the object 30 in an x direction, a y direction, and a z direction and change the posture of the object 30 in a rotation direction about a y-axis.

The projector 22 irradiates the object 30 with the measurement light from a direction that is inclined at an angle a from the z direction to the x direction. Striped pattern light or uniformly emitted monochromatic light is used as the measurement light. A light field camera 20 is disposed at a position away from the object 30 in the z direction. A distance from the object 30 to the projector 22 is, for example, 430 mm, and a distance from the object 30 to the light field camera 20 is, for example, 400 mm. The angle a is 60°.

In addition, the distances are adjusted by a focal length of the projector 22, a focal length of a main lens of the light field camera 20, a size of a light receiving surface of the light field camera 20, and the like. For example, the distance from the object 30 to the projector 22 is adjusted such that the pattern light emitted from the projector 22 is focused on the surface of the object 30. In addition, the distance from the object 30 to the light field camera 20 is adjusted such that the object 30 fits within the light receiving surface of the light field camera 20. Further, the angle a may be set to a value other than 60°, or an optical axis of the light field camera 20 may be inclined in a zx plane from the z direction.

Next, the definition of the angle of an intensity distribution of scattered light from the surface of the object 30 will be described. An inclination angle of the scattered light from a specific portion of the surface of the object 30 in the z direction is represented by θ. The sign of the inclination angle θ toward an incident ray side is defined as a positive sign, and the sign of the inclination angle θ toward an opposite side is defined as a negative sign. The scattered light intensity distribution is obtained as a function of the angle θ.

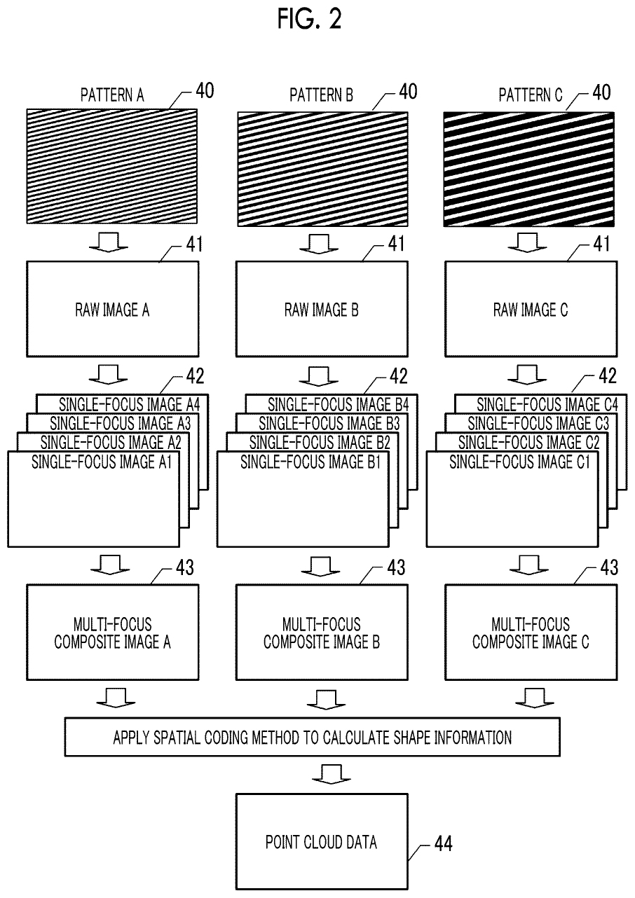

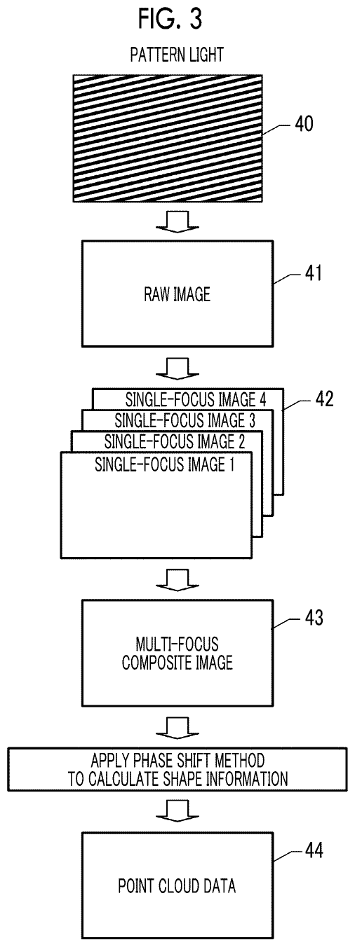

The surface roughness calculation device 10 has a raw image acquisition unit 11, a multi-focus composite image generation unit 12, a shape calculation unit 13, a scattered light intensity calculation unit 14, a surface roughness calculation unit 15, and an output unit 16. The raw image acquisition unit 11 acquires a raw image (RAW image) captured by the light field camera 20. The multi-focus composite image generation unit 12 generates a plurality of single-focus images from the raw image acquired by the raw image acquisition unit 11 and combines the plurality of single-focus images to generate a multi-focus composite image. The shape calculation unit 13 applies a spatial coding method or a phase shift method to the multi-focus composite image generated by the multi-focus composite image generation unit 12 to calculate shape information of the surface of the object 30. A method of calculating the shape information will be described below with reference to FIGS. 2 and 3. The shape information is represented by, for example, point cloud data including a plurality of points whose positions are defined by three-dimensional coordinates. The shape calculation unit 13 outputs the calculated shape information to the output unit 16.

The scattered light intensity calculation unit 14 calculates the scattered light intensity distribution of the surface of the object 30 based on a light field obtained from the raw image acquired by the raw image acquisition unit 11. The light field includes information related to a start point and a traveling direction of a ray in a three-dimensional space. The start point of the ray is represented by two-dimensional coordinates defining the position of the ray with respect to the optical axis of the light field camera 20. The traveling direction of the ray is represented by inclination angles from the optical axis of the light field camera 20 in two directions. As described above, the light field is a four-dimensional ray field including information related to the start point and the traveling direction of the ray.

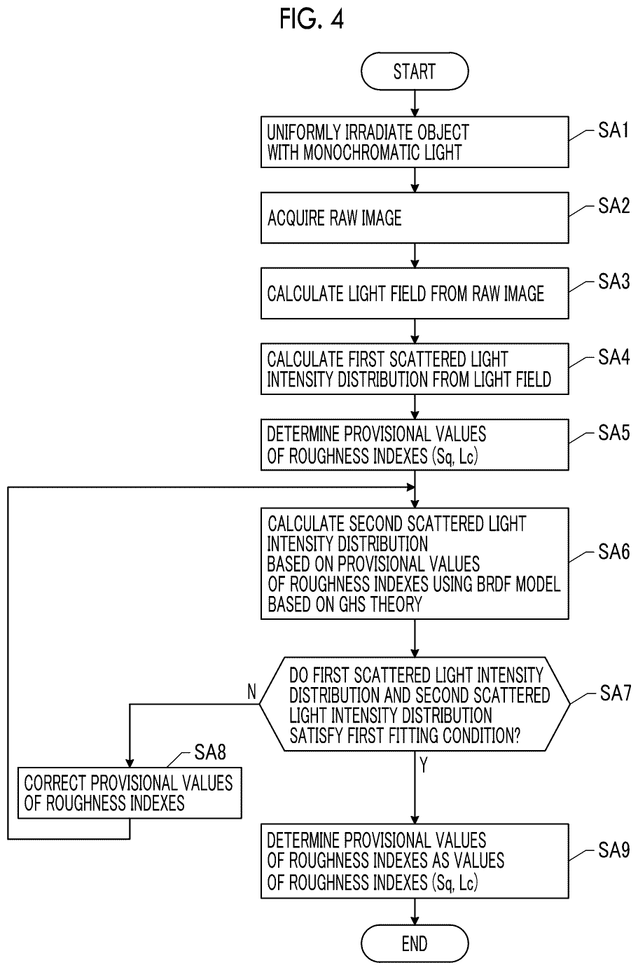

The surface roughness calculation unit 15 calculates a surface roughness index of the object 30 and outputs the calculation result to the output unit 16. A method of calculating the surface roughness index will be described below with reference to FIGS. 4 to 9C.

Next, a method of calculating the shape information using the spatial coding method will be described with reference to FIG. 2.

FIG. 2 is a view schematically showing image data generated in each stage when the method of calculating the shape information using the spatial coding method is executed. First, a predetermined pattern is projected from the projector 22 (FIG. 1) to the object 30. Then, a light and dark pattern 40 appears on the surface of the object 30. For example, the pattern 40 is a linear striped pattern, and the projector 22 can project a plurality of patterns having different stripe pitches. For example, three patterns A, B, and C having different stripe pitches can be projected.

The raw image acquisition unit 11 acquires a raw image 41 for each pattern. For example, raw images A, B, and C are acquired for the patterns A, B, and C, respectively. The multi-focus composite image generation unit 12 generates a plurality of single-focus images 42 for each of the raw images 41. For example, a plurality of single-focus images A1, A2, A3, and A4 are generated from the raw image A, a plurality of single-focus images B1, B2, B3, and B4 are generated from the raw image B, and a plurality of single-focus images C1, C2, C3, and C4 are generated from the raw image C. The plurality of single-focus images 42 are a plurality of two-dimensional images having different in-focus positions.

In addition, the multi-focus composite image generation unit 12 combines the plurality of single-focus images 42 generated from one raw image 41 to generate one multi-focus composite image 43. The multi-focus composite image 43 is a two-dimensional image in which any portion of the surface of the object 30 is in focus. For example, it can be said that the multi-focus composite image is a two-dimensional image with a large depth of field. For example, multi-focus composite images A, B, and C are generated from the raw images A, B, and C, respectively. Image distortion correction may be performed on each of the plurality of multi-focus composite images 43 in order to compensate for various types of distortion of the light field camera 20.

The shape calculation unit 13 (FIG. 1) applies the spatial coding method to the plurality of multi-focus composite images 43 to calculate shape information. For example, the shape information is represented by point cloud data 44 including a plurality of points whose three-dimensional coordinates are defined.

In FIG. 2, three types of patterns A, B, and C are used. However, four or more types of patterns may be used. In addition, four single-focus images 42 are generated from one raw image 41. However, five or more single-focus images 42 may be generated.

Next, a method of calculating the shape information using the phase shift method will be described with reference to FIG. 3.

FIG. 3 is a view schematically showing image data generated in each stage when the method of calculating the shape information using the phase shift method is executed. When the shape information is calculated using the spatial coding method, the multi-focus composite image 43 is generated for each of the plurality of patterns 40 having different stripe pitches. In contrast, when the phase shift method is used, only one pattern 40 is projected. One multi-focus composite image 43 is generated for one pattern 40. The phase shift method is applied to the one multi-focus composite image 43 to calculate shape information. The shape information is represented by, for example, the point cloud data 44.

Next, a method of calculating a surface roughness index will be described with reference to FIGS. 4 to 9C.

FIG. 4 is a flowchart showing a procedure of calculating the surface roughness index.

It is assumed that the surface of the object 30 is described by Gaussian autocovariance. A rough surface autocovariance Cs is described by the following equation.

$$\begin{matrix}[ Equation 1 ] & \\ {C}_{s} = R {q}^{2} {e}^{- \frac{{\hat{r}}^{2}}{{\hat{Lc}}^{2}}} & ( 1 )\end{matrix}$$

Here, r-hat is a parameter obtained by scaling the distance from the origin of two-dimensional polar coordinates defined on the rough surface with a wavelength λ of an incident laser beam. Lc-hat is a parameter obtained by scaling a surface correlation length Lc with the wavelength λ of the incident laser beam.

First, monochromatic light is output from the projector 22 (FIG. 1) to uniformly irradiate the object 30 (Step SA1). For example, blue light having a wavelength of 470 nm is used as the monochromatic light. In addition, monochromatic light having another wavelength may be used. The raw image acquisition unit 11 acquires a raw image when the object is uniformly irradiated with the monochromatic light (Step SA2). The scattered light intensity calculation unit 14 calculates a light field from the raw image (Step SA3).

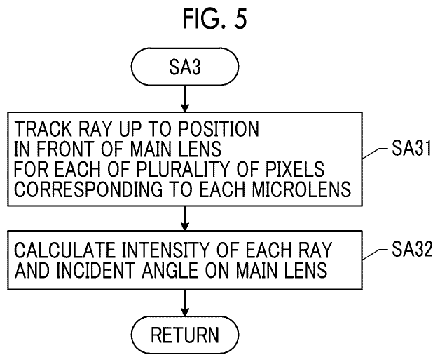

FIG. 5 is a flowchart showing a procedure of Step SA3. The light field camera 20 includes a large number of microlenses and a plurality of pixels disposed to correspond to each of the microlenses. A ray that has passed through the main lens is incident on any one of the microlenses. The ray that has passed through the microlens is incident on any one of the pixels. First, the scattered light intensity calculation unit 14 tracks the ray up to the position in front of the main lens for each of the plurality of pixels corresponding to each of the microlenses (Step SA31). The intensity of each ray and the incident position and incident angle of each ray on the main lens are calculated based on the intensity of light received by each pixel and the tracking result of the ray (Step SA32). The light field is defined by the incident position and incident angle of each of the plurality of rays on the main lens.

When the light field is calculated in Step SA3, a scattered light intensity distribution is calculated (Step SA4). It is assumed that the scattered light intensity distribution obtained from the actual raw image is referred to as a first scattered light intensity distribution.

Then, a provisional value of the roughness index is determined (Step SA5). In one embodiment, the provisional values of a root mean square roughness Sq and the surface correlation length Lc are determined as the roughness indexes. The provisional values determined here are preset as, for example, initial values.

Then, an angular distribution of the intensity of the scattered light is obtained by calculation based on the provisional values of the root mean square roughness Sq and the surface correlation length Lc, using a bidirectional reflectance distribution function (BRDF) model based on a generalized Harvey-Shack theory (GHS theory) (Step SA6). It is assumed that the angular distribution of the intensity of the scattered light calculated in Step SA6 is referred to as a second scattered light intensity distribution. A method of calculating the second scattered light intensity distribution using the BRDF model based on the GHS theory will be described below.

When the second scattered light intensity distribution is calculated, the first scattered light intensity distribution calculated in Step SA4 and the second scattered light intensity distribution calculated in Step SA6 are compared to determine whether both satisfy a first fitting condition (Step SA7). A method of determining whether the first scattered light intensity distribution and the second scattered light intensity distribution satisfy the first fitting condition will be described below.

When the first scattered light intensity distribution and the second scattered light intensity distribution do not satisfy the first fitting condition, the provisional values of the roughness indexes, that is, the root mean square roughness Sq and the surface correlation length Lc, are corrected (Step SA8), and the second scattered light intensity distribution is recalculated (Step SA6). The provisional values of the root mean square roughness Sq and the surface correlation length Lc are corrected until the first fitting condition is satisfied. When the first scattered light intensity distribution and the second scattered light intensity distribution satisfy the first fitting conditions, the provisional values of the roughness indexes at the present time, that is, the root mean square roughness Sq and the surface correlation length Lc, are determined to be the values of the root mean square roughness Sq and the surface correlation length Lc (Step SA9).

### Calculation of Second Scattered Light Intensity Distribution

Next, a method of calculating the second scattered light intensity distribution using the BRDF model based on the GHS theory will be briefly described. In addition, the BRDF model based on the GHS theory is described in detail in V.E. Johansen, “Preparing the generalized Harvey-Schack rough surface scattering method for use with the discrete ordinates method”, J. of Optical Society of America, Vol. 32, No. 2, February 2015.

An angular distribution I of the intensity of reflected light can be described by the following equation using the polar angle and azimuth angle of a polar coordinate system.

$$\begin{matrix}[ Equation 2 ] & \\ I ( {θ}_{i} , {ϕ}_{i} , {θ}_{s} , {ϕ}_{s} , λ ) = cos ( {θ}_{s} ) B R D F ( {θ}_{i} , {ϕ}_{i} , {θ}_{s} , {ϕ}_{s} , λ ) & ( 2 )\end{matrix}$$

Here, λ is the wavelength of the incident laser beam. θ and φ are the polar angle and azimuth angle of the polar coordinate system, respectively. The polar angle θ and the azimuth angle φ can be expressed by direction cosines α, β, and γ as in the following equation.

$$\begin{matrix}[ Equation 3 ] & \\ α = sin θ cos ϕ & ( 3 )\end{matrix}$$

$$β = sin θ sin ϕ$$

$$γ = cos θ$$

One of three variables α, β, and γ in Equation (3) can be represented using the other two variables. The subscript i indicates an incident angle, and the subscript s indicates a scattering angle.

BRDF is a bidirectional reflectance distribution function and is described by the following equation.

$$\begin{matrix}[ Equation 4 ] & \\ BRDF ( {θ}_{i} , {ϕ}_{i} , {θ}_{s} , {ϕ}_{s} , λ ) = R ( {θ}_{i} ) ASF ( {θ}_{i} , {ϕ}_{i} , {θ}_{s} , {ϕ}_{s} ) {\vert}_{λ} & ( 4 )\end{matrix}$$

Here, R(θᵢ) is Fresnel reflection radiant intensity determined by the incident angle. ASF is an angle spread function and can be described using the direction cosine variables α and β instead of the polar angle θ and the azimuth angle φ. In addition, it can be assumed that βᵢ is 0 without impairing the generality. That is, the coordinate system is defined such that the azimuth angle qi of the incident laser beam is 0°.

The angle spread function ASF is defined by the following equation.

$$\begin{matrix}[ Equation 5 ] & \\ A S F ( {α}_{i} , {α}_{s} , {β}_{s} ) = A ( {γ}_{i} , {γ}_{s} ) δ ( {α}_{s} - {α}_{o} , {β}_{s} ) + K ( {γ}_{i} ) S ( {α}_{1} , {α}_{s} , {β}_{s} ) & ( 5 )\end{matrix}$$

Here, the subscript o indicates a specular reflection angle. The first term on the right side of Equation (5) indicates a reflection component of the ASF, and K in the second term on the right side is a renormalization constant for standardization. S in the second term on the right side indicates a distribution of scattered components of the ASF and is defined by the following equation.

$$\begin{matrix}[ Equation 6 ] & \\ S ( {α}_{i} , {α}_{s} , {β}_{s} ) = B ( {γ}_{i} , {γ}_{s} ) F \{ G ( \hat{x} , \hat{y} , {γ}_{i} , {γ}_{s} ) {e}^{- i 2 {πα}_{o} \hat{x}} \} & ( 6 )\end{matrix}$$

Here, B is a ratio of the scattered light components and is defined by the following equation.

$$\begin{matrix}[ Equation 7 ] & \\ B ( {γ}_{i} , {γ}_{s} ) = 1 - A ( {γ}_{i} , {γ}_{s} ) & ( 7 )\end{matrix}$$

F is a Fourier transformation operator, and G is a surface shape function. The function G includes the rough surface autocovariance Cs (Equation (1)). That is, the function G includes the root mean square roughness Sq and the surface correlation length Lc of the rough surface as variables. x-hat and y-hat are variables obtained by scaling the x coordinate and the y coordinate on the rough surface with the wavelength λ.

When the provisional values of the root mean square roughness Sq and the surface correlation length Lc are determined, the angular distribution I of the intensity of the scattered light (Equation (2)) can be obtained by calculation.

### Determination of Whether First Fitting Condition is Satisfied

Before it is determined whether the first fitting condition is satisfied, a noise removal process is performed on the first scattered light intensity distribution calculated in Step SA4. A Fourier analysis method, a multi-resolution analysis method, a singular spectrum analysis method, and the like can be given as candidates for a noise removal method. In addition, when sufficient fitting can be performed using the first scattered light intensity distribution before the noise removal process is performed, the noise removal process may not be performed.

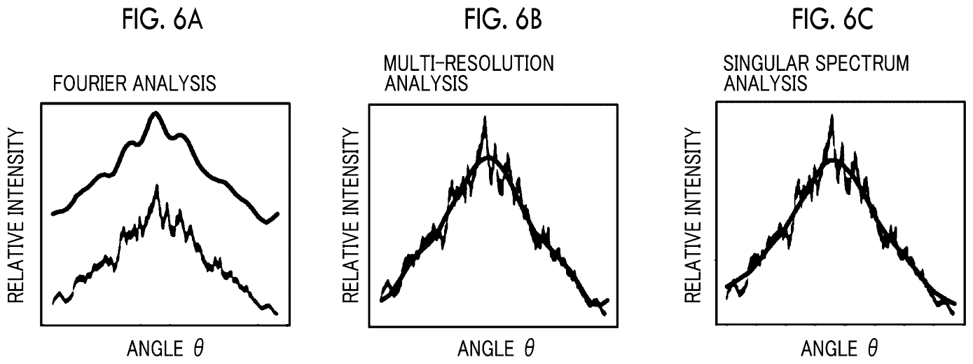

FIGS. 6A, 6B, and 6C show examples of the first scattered light intensity distribution before noise removal and after noise removal when noise is removed using the Fourier analysis method, the multi-resolution analysis method, and the singular spectrum analysis method, respectively. The horizontal axis indicates an angle θ (FIG. 1), and the vertical axis indicates relative intensity. A thin polygonal line indicates the first scattered light intensity distribution before noise removal, and a thick smooth curve indicates the first scattered light intensity distribution after noise removal.

A determination coefficient R² between the first scattered light intensity distribution before noise removal and the first scattered light intensity distribution after noise removal is 0.987 when the Fourier analysis method is used, is 0.979 when the multi-resolution analysis method is used, and is 0.981 when the singular spectrum analysis method is used. In order to improve the accuracy of determining whether the first fitting condition is satisfied (Step SA5), it is preferable to adopt a noise removal method in which the determination coefficient R² between the first scattered light intensity distribution before noise removal and the first scattered light intensity distribution after noise removal is large.

When the Fourier analysis method is used, the determination coefficient R² has the largest value. However, when the Fourier analysis method is used, the first scattered light intensity distribution after noise removal is offset from the first scattered light intensity distribution before noise removal. It is preferable to perform noise removal using the singular spectrum analysis method in which the offset does not occur and a large determination coefficient R² is obtained.

An Akaike information criterion (AIC) is used in order to evaluate the quality of the first scattered light intensity distribution after noise removal calculated by the singular spectrum analysis. The AIC is defined by the following equation.

$$\begin{matrix}[ Equation 8 ] & \\ AIC = - 2 \times ln ( {R}^{2} ) + 2 \times k & ( 8 )\end{matrix}$$

Here, R² is a determination coefficient, and k is a window size in the singular spectrum analysis. When the example shown in FIG. 6C is applied, R² is 0.981 and k is 0.2. In this case, the AIC is 0.438. As shown in FIG. 6C, when the AIC is equal to or less than 0.438, the distribution after noise removal can be evaluated to be good. When the singular spectrum analysis is performed to remove noise, it is preferable to use the determination coefficient R² and the window size k at which the AIC is equal to or less than 0.438.

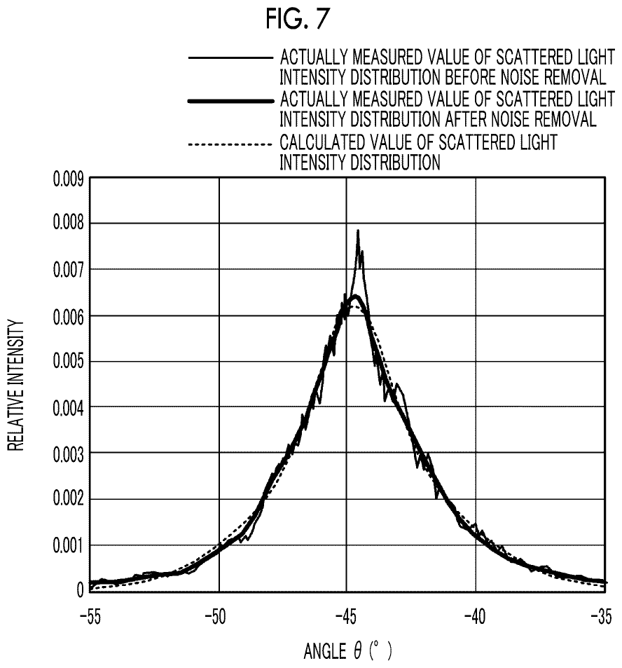

FIG. 7 is a graph showing an example of the first scattered light intensity distribution before noise removal, the first scattered light intensity distribution after noise removal, and the second scattered light intensity distribution when the first fitting condition is satisfied. The horizontal axis indicates the angle θ in units of “°”, and the vertical axis indicates the relative intensity of the scattered light. In FIG. 7, a thin solid line, a thick solid line, and a broken line indicate the first scattered light intensity distribution before noise removal, the first scattered light intensity distribution after noise removal, and the second scattered light intensity distribution, respectively. For example, when the determination coefficient R² between the first scattered light intensity distribution after noise removal and the second scattered light intensity distribution is equal to or greater than a determination threshold value, it is determined that the first fitting condition is satisfied. For example, 0.9 can be adopted as the determination threshold value.

Further, another method of evaluating the similarity between two signal waveforms may be used as the first fitting condition.

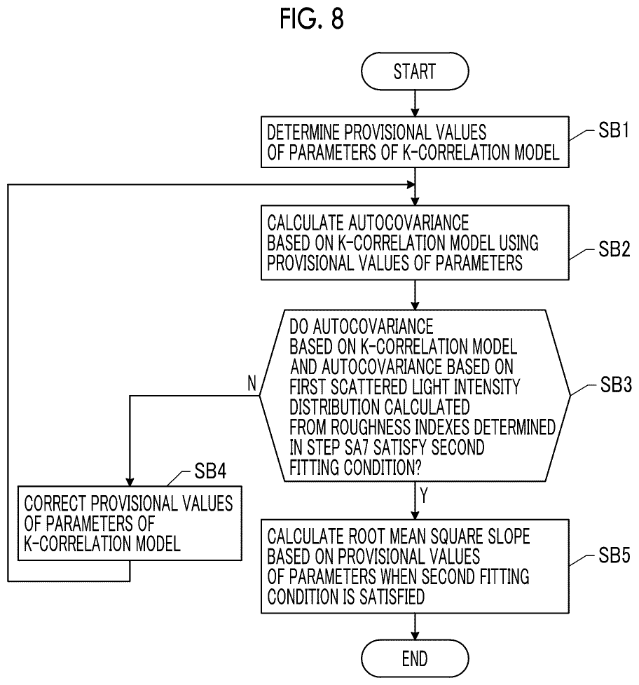

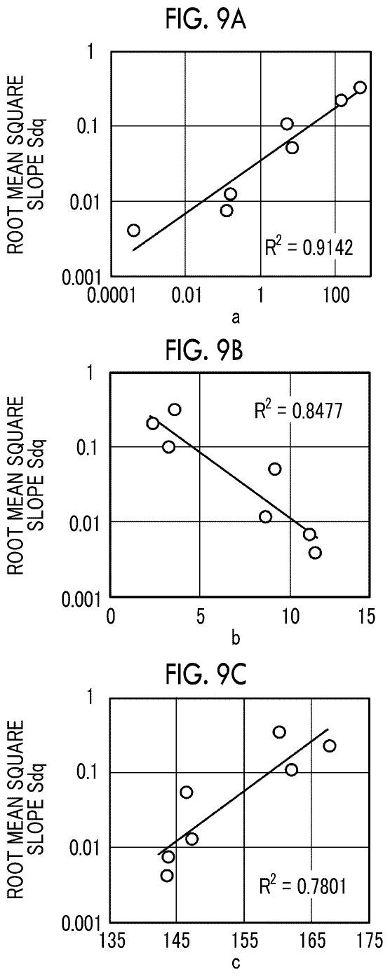

Next, a method of calculating a root mean square slope Sdq will be described with reference to FIGS. 8 to 9C.

FIG. 8 is a flowchart showing the method of calculating the root mean square slope Sdq. A K-correlation model is used to calculate the root mean square slope Sdq. First, the provisional values of parameters of the K-correlation model are determined (Step SB1). For example, the initial values of the provisional values are preset.

In the K-correlation model, an autocovariance ACV(r) of a two-dimensional Gaussian distribution is described by the following equation.

$$\begin{matrix}[ Equation 9 ] & \\ ACV ( r ) = \sqrt{2 π} \frac{a}{b} \frac{{2}^{- \frac{c}{2}}}{Γ ( \frac{c}{2} )} {( \frac{2 π r}{b} )}^{\frac{c - 1}{2}} {K}_{\frac{c - 1}{2}} ( \frac{2 π r}{b} ) & ( 9 )\end{matrix}$$

Here, the autocovariance ACV(r) is the distance from the origin when a two-dimensional plane is represented by polar coordinates. In the K-correlation model, the autocovariance ACV is a function of only a distance r. In Equation (9), Γ is a gamma function, Kα is the modified Bessel function of the second kind of order α, and a, b, and c are parameters of the K-correlation model. In Step SB1, the provisional values of the three parameters a, b, and c are determined.

Then, the autocovariance ACV(r) is calculated by Equation (9) using the provisional values of the parameters a, b, and c (Step SB2). The autocovariance ACV(r) obtained by the calculation in Step SB2 and the autocovariance Cs (Equation (1)) determined based on the root mean square roughness Sq and the surface correlation length Lc determined in Step SA9 (FIG. 4) are compared with each other to determine whether both satisfy a second fitting condition (Step SB3). For example, the shapes of the graphs of the two autocovariances are compared with each other using the determination coefficient R². When the determination coefficient R² is equal to or greater than the determination threshold value, it is determined that the second fitting condition is satisfied. In addition, another method of evaluating the similarity of the graphs of the two autocovariances may be used.

When the second fitting condition is not satisfied, the provisional values of the parameters a, b, and c are corrected (Step SB4), and the autocovariance ACV(r) by the K-correlation model is recalculated (Step SB2). The provisional values of the parameters a, b, and c are corrected until the second fitting condition is satisfied. When the second fitting condition is satisfied, the root mean square slope Sdq is calculated based on the provisional values of the parameters a, b, and c at the present time (Step SB5).

Next, a method of calculating the root mean square slope Sdq will be described with reference to FIGS. 9A to 9C. FIGS. 9A to 9C are graphs showing the relationships between the parameters a, b, and c and an actually measured value of the root mean square slope Sdq, respectively. The surface roughnesses of a plurality of samples were measured using a contact-type surface roughness measurement device, and the root mean square slope Sdq was calculated. Furthermore, the intensity distributions of the scattered light from the surfaces of these samples were measured, and the parameters a, b, and c were calculated from the measurement results. The relationships between the parameters a, b, and c calculated for each sample and the root mean square slope Sdq are represented by circle symbols. A straight line in the graph indicates a regression line.

As shown in FIGS. 9A to 9C, the root mean square slope Sdq has a positive correlation with the parameters a and c and has a negative correlation with the parameter b. Therefore, when at least one of the parameters a, b, and c is determined, it is possible to estimate the root mean square slope Sdq of the surface of the object 30 from any one of the correlations shown in FIGS. 9A to 9C.

For R² values in linear approximation in FIGS. 9A, 9B, and 9C, R²=0.9142, R²=0.8477, and R²=0.7801 were established, respectively. The R² value of the relationship between the parameter a and the root mean square slope Sdq is the largest value. Therefore, it is preferable to use the parameter a in estimating the root mean square slope Sdq.

In FIGS. 9A to 9C, the correlation between each of the parameters a, b, and c and the root mean square slope Sdq is calculated. However, a function f(a, b, c) including the parameters a, b, and c as variables may be defined, and a correlation between the function f(a, b, c) and the root mean square slope Sdq may be calculated. In order to improve the accuracy of estimating the root mean square slope Sdq, a function that maximizes the R² value may be adopted as the function f(a, b, c).

Next, an excellent effect of one embodiment will be described.

In one embodiment, it is possible to calculate the surface roughness without using the Ward BRDF model. Therefore, it is possible to suppress a reduction in calculation accuracy caused by using the Ward BRDF model.

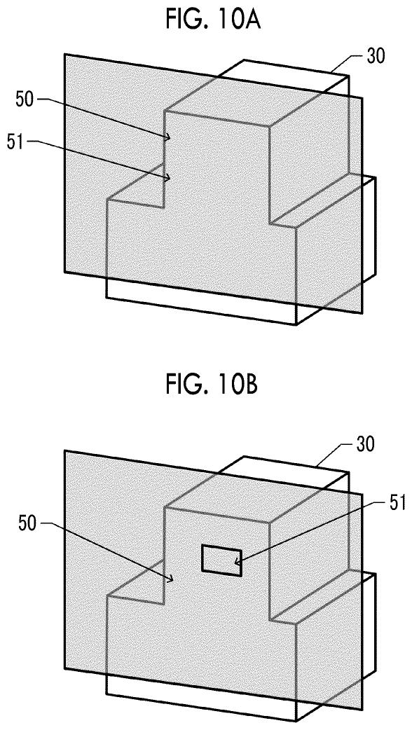

Next, another excellent effect of one embodiment will be described with reference to FIGS. 10A and 10B.

FIG. 10B is a schematic view showing a shape measurement area 50 and a surface roughness measurement area 51 of the object 30 that can be measured by the method according to the related art that is generally put into practical use. In the method according to the related art, the surface roughness measurement area 51 is smaller than the shape measurement area 50 in one data acquisition operation.

FIG. 10A is a schematic view showing a shape measurement area 50 and a surface roughness measurement area 51 of the object 30 that can be measured by the measurement apparatus according to one embodiment. In one embodiment, the surface of the object 30 is irradiated with the measurement pattern light or the uniform monochromatic light from the projector 22 (FIG. 1). The shape information can be calculated in the irradiated range using the spatial coding method or the like, and the surface roughness information can be calculated by the scattered light intensity distribution. That is, the shape information and the surface roughness information can be acquired in a common wide region.

In the general non-contact roughness measurement method according to the related art, the roughness is recognized as a surface shape using the interference of white scattered light, laser reflected light, or the like, and the surface roughness index is calculated from the recognized surface shape. An optical device tends to be more complex in order to recognize the surface shape. In one embodiment, as shown in FIG. 4, it is possible to directly calculate the surface roughness index from the first scattered light intensity distribution calculated from the actually measured raw image, without calculating the shape information. Therefore, a complex optical system for converting the information related to the scattered light intensity distribution into the shape information is not required.

In addition, in one embodiment, the multi-focus composite image 43 (FIG. 2) obtained from the raw image 41 (FIG. 2) is an image in which any portion of the surface of the object 30 is in focus. Therefore, it is possible to calculate the shape information with high accuracy without performing focus depth correction.

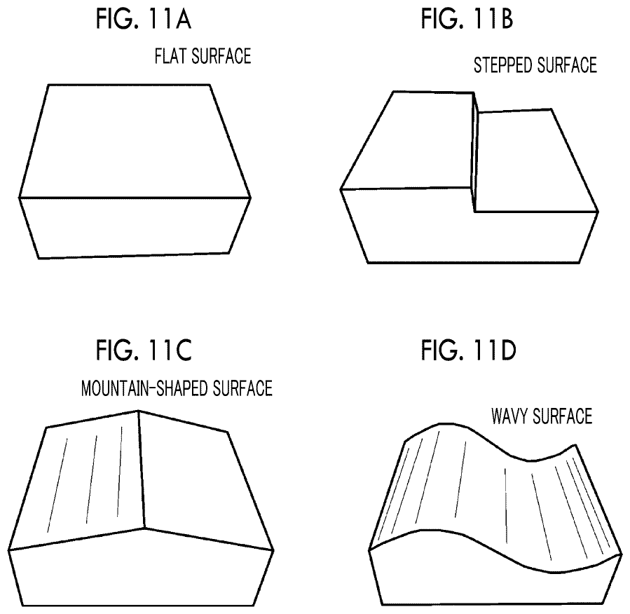

Next, the results of measuring the root mean square roughness Sq using the measurement apparatus including the calculation device according to one embodiment will be described with reference to FIGS. 11A to 13D while being compared with the results measured by another method.

FIGS. 11A to 11D are perspective views showing four types of samples whose surface roughnesses have been actually measured. In the sample shown in FIG. 11A, the surface to be measured is a flat surface. In the sample shown in FIG. 11B, the surface to be measured is a stepped surface having steps. In the sample shown in FIG. 11C, the surface to be measured is a mountain-shaped surface. In the sample shown in FIG. 11D, the surface to be measured is a wavy surface.

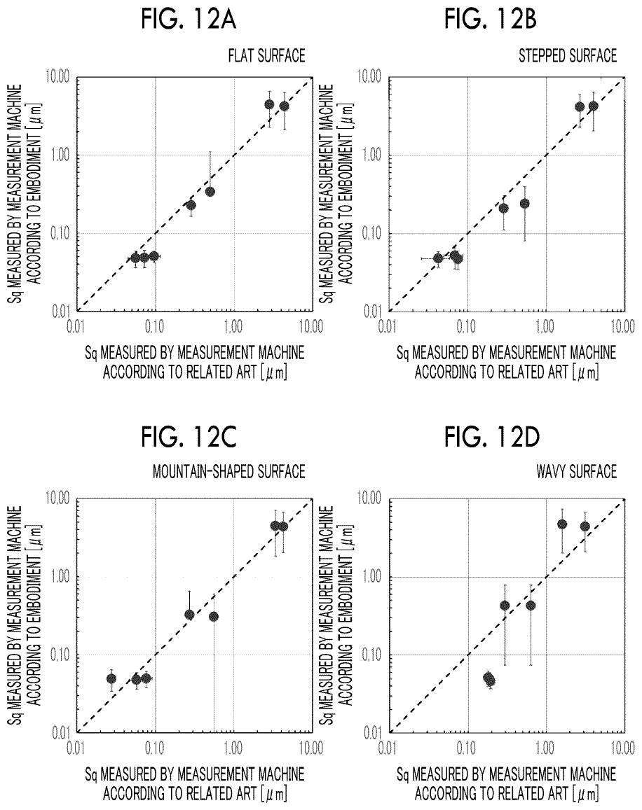

FIGS. 12A to 12D are scatter diagrams showing the relationship between the root mean square roughness Sq measured using a laser microscope equipped with a white light interferometer according to the related art and the root mean square roughness Sq measured using the calculation device according to one embodiment. FIGS. 12A, 12B, 12C, and 12D show measurement results of the samples shown in FIGS. 11A, 11B, 11C, and 11D, respectively. The horizontal axis indicates the root mean square roughness Sq measured using the laser microscope according to the related art in units of [μm], and the vertical axis indicates the root mean square roughness Sq measured using the calculation device according to one embodiment in units of [μm]. The root mean square roughnesses (Sq) of a plurality of portions of the surface of the sample are measured, and the root mean square roughness (Sq) of each measurement portion is plotted.

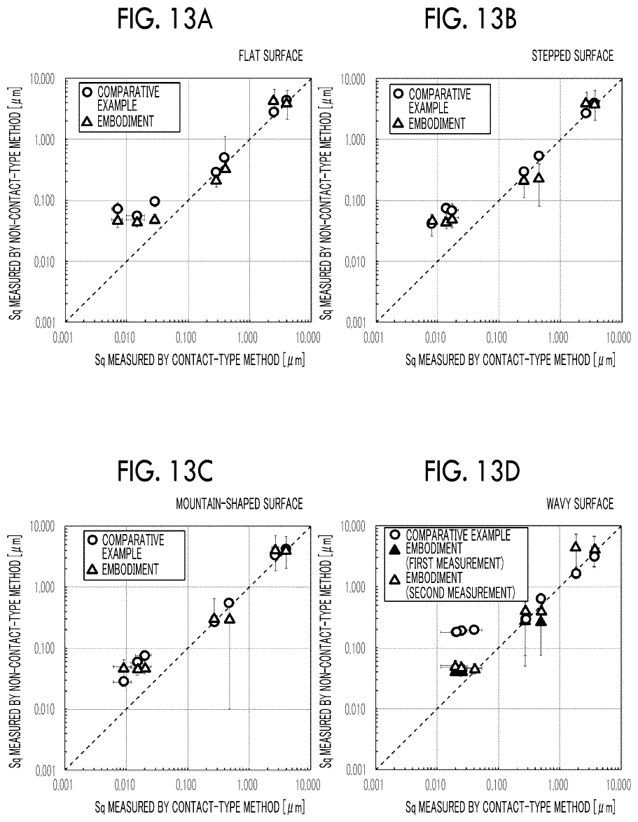

In all of FIGS. 12A to 12D, the measurement results by one embodiment are well matched with the measurement results obtained by the laser microscope according to the related art. It was confirmed that the calculation device according to one embodiment could measure the surface roughness with the same degree of accuracy as the laser microscope according to the related art. In the plot positioned at the bottom left in FIG. 12D, the difference between the measurement result by one embodiment and the measurement result by the laser microscope according to the related art is large. The difference between the measurement results will be described below with reference to FIG. 13D.

FIGS. 13A to 13D are scatter diagrams showing the relationship between the root mean square roughness Sq measured using a contact-type surface roughness meter and the root mean square roughness Sq measured using a non-contact-type measurement device.

FIGS. 13A, 13B, 13C, and 13D show the measurement results of the samples shown in FIGS. 11A, 11B, 11C, and 11D, respectively. The horizontal axis indicates the root mean square roughness Sq measured using the contact-type surface roughness meter in units of [μm], and the vertical axis indicates the root mean square roughness Sq measured using the non-contact-type measurement device in units of [μm]. The root mean square roughnesses (Sq) of a plurality of portions of the surface of the sample are measured, and the root mean square roughness (Sq) of each measurement portion is plotted.

In FIGS. 13A to 13D, a circle symbol indicates the result measured using the laser microscope according to the related art, and a triangle symbol indicates the result measured using the calculation device according to one embodiment. FIG. 13D shows the results of two measurement operations by the calculation device according to one embodiment. A black triangle symbol indicates the result of the first measurement operation, and a hollow triangle symbol indicates the result of the second measurement operation.

As shown in FIGS. 13A to 13D, the results measured by one embodiment and the laser microscope according to the related art are well matched with the results measured using the contact-type surface roughness meter. However, in the leftmost plot in FIG. 13D, the measurement result obtained by the calculation device according to one embodiment is well matched with the measurement result obtained by the contact-type surface roughness meter, but the difference between the measurement result obtained by the laser microscope and the measurement result obtained by the contact-type surface roughness meter is large. This corresponds to the fact that the difference between the measurement result by one embodiment and the measurement result by the laser microscope is large in the lower left plot in FIG. 12D.

Next, the reason why the difference between the measurement result obtained by the laser microscope and the measurement result obtained by the contact-type surface roughness meter is large will be described. An objective lens of a microscope needs to be brought close to the surface of the sample in order to measure the surface roughness with the laser microscope. For example, a working distance is about 0.5 mm. When the surface is the wavy surface shown in FIG. 11D, it is difficult to bring the objective lens close to the wavy surface. Therefore, it is considered that the error of the measurement result has increased.

In contrast, in one embodiment, as shown in FIG. 1, even when the distance from the object 30 to the light field camera 20 is increased to about 400 mm, the measurement error does not increase. As described above, the measurement apparatus according to one embodiment is advantageous in measuring the surface roughness of a curved surface, such as a wavy surface, as compared to the laser microscope according to the related art. Next, modification examples of one embodiment will be described.

In one embodiment, as shown in FIGS. 2 and 3, the striped pattern is projected when the shape information is calculated. However, other patterns may be projected.

In one embodiment, as shown in FIG. 4, the object 30 (FIG. 1) is uniformly irradiated with monochromatic light when the surface roughness index is calculated (Step SA1). The procedure of uniformly irradiating the object with monochromatic light may be omitted, which will be described below.

A plurality of different patterns 40 are projected onto the object 30 in order to calculate the shape information shown in FIG. 2. When monochromatic light is used to project the patterns 40 and the union of the regions on which the monochromatic light is incident by the projection of each of the plurality of patterns includes the surface to be measured in the object 30, the raw image obtained by the projection of the plurality of patterns may be used to calculate the surface roughness index.

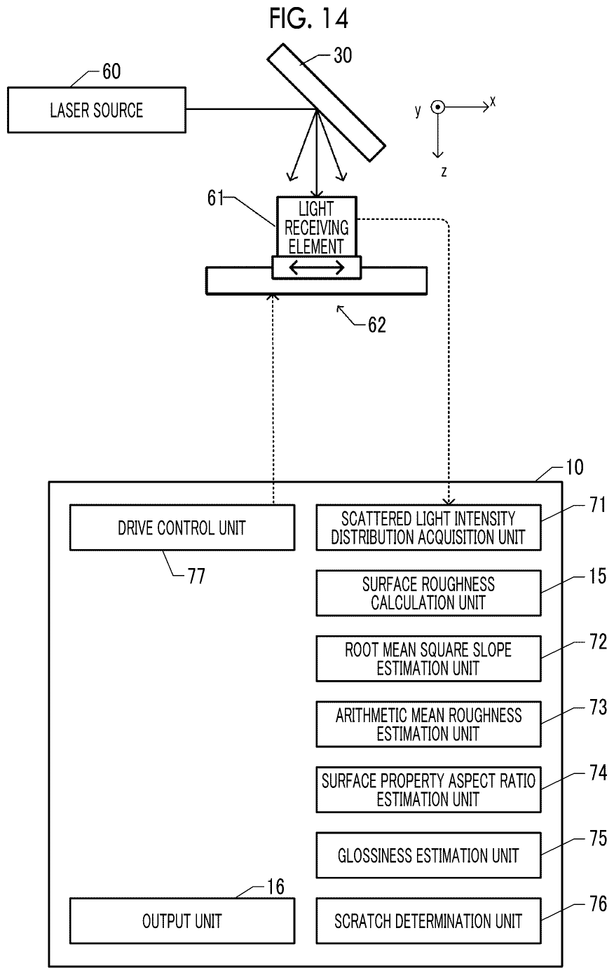

Next, a surface roughness calculation device according to another embodiment will be described with reference to FIGS. 14 to 29C. Hereinafter, a description of a configuration common to the surface roughness calculation device according to one embodiment will be omitted.

FIG. 14 is a schematic view showing a surface roughness measurement apparatus including the surface roughness calculation device according to another embodiment. A measurement portion of the surface roughness calculation device includes a laser source 60, a light receiving element 61, and a light receiving element moving mechanism 62. FIG. 14 shows a schematic positional relationship among the laser source 60, the light receiving element 61, and the light receiving element moving mechanism 62 in a horizontal plane. A measurement laser beam is incident on the object 30 whose surface roughness is to be measured from the laser source 60. A portion of scattered light from a laser beam incident position on the surface of the object 30 is incident on the light receiving element 61.

An xyz orthogonal coordinate system is defined in which a traveling direction of specularly reflected light from the object 30 is the positive direction of a z-axis and a vertically upward direction is the positive direction of the y-axis. The xz plane is parallel to the horizontal plane. The light receiving element moving mechanism 62 supports the light receiving element 61 to be movable in two directions that are perpendicular to the z-axis and that are perpendicular to each other. For example, a He—Ne laser oscillator is used as the laser source 60. For example, a PIN photodiode is used as the light receiving element 61.

The surface roughness calculation device 10 includes a drive control unit 77, a scattered light intensity distribution acquisition unit 71, a surface roughness calculation unit 15, a root mean square slope estimation unit 72, an arithmetic mean roughness estimation unit 73, a surface property aspect ratio estimation unit 74, a glossiness estimation unit 75, a scratch determination unit 76, and an output unit 16.

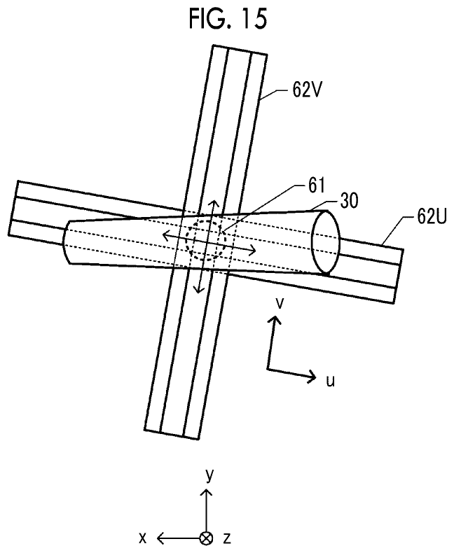

FIG. 15 is a schematic front view when the light receiving element 61 and the light receiving element moving mechanism 62 are viewed from the negative side to the positive side of the z-axis. The object 30 is visible in front, and the light receiving element 61 is disposed behind the object 30. The object 30 has a rod shape. As an example, a center axis direction of the object 30 is parallel to the xz plane and is inclined at 45° with respect to the z-axis.

The light receiving element moving mechanism 62 includes a U-direction moving mechanism 62U and a V-direction moving mechanism 62V. The U-direction moving mechanism 62U and the V-direction moving mechanism 62V move the light receiving element 61 in a u direction and a v direction that are parallel to the xy plane and that are perpendicular to each other. For example, the u direction and the v direction are slightly inclined with respect to the x direction and the y direction, respectively. A side surface of the object 30 is cut to form a processed bar. As an example, a direction parallel to the processed bar at a beam spot position is set as the v direction. An inclination angle of the v direction with respect to the y direction can be changed depending on the direction of the processed bar.

The scattered light from the object 30 is received while the light receiving element 61 is moved in the u direction, which makes it possible to measure the angular distribution of the intensity of the scattered light reflected in the direction parallel to the uz plane. Similarly, the scattered light from the object 30 is received while the light receiving element 61 is moved in the v direction, which makes it possible to measure the angular distribution of the intensity of the scattered light reflected in the direction parallel to the vz plane.

The drive control unit 77 shown in FIG. 14 controls the movement of the light receiving element 61 by the light receiving element moving mechanism 62. The scattered light intensity distribution acquisition unit 71 acquires information of the angular distribution of the intensity of the scattered light from the intensity of the scattered light measured by the light receiving element 61 and control information for the movement of the light receiving element 61 by the drive control unit 77.

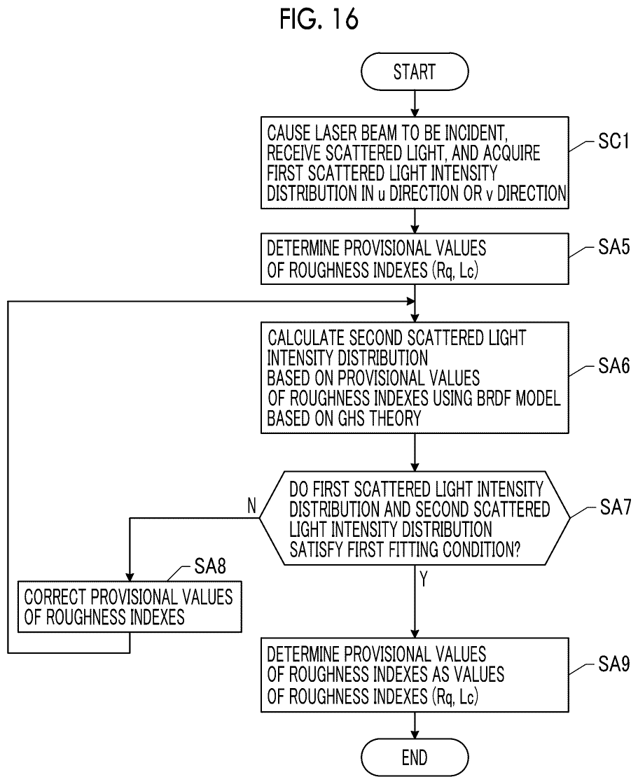

FIG. 16 is a flowchart showing a procedure in which the surface roughness calculation unit 15 of the surface roughness calculation device according to another embodiment calculates the surface roughness index. In one embodiment (FIG. 4), the object is uniformly irradiated, and the first scattered light intensity distribution is calculated from the raw image acquired by the light field camera 20 (Steps SA1 to SA4). In contrast, in another embodiment, the laser beam is incident on a portion to be measured in the object 30 from the laser source 60 (FIG. 1), and the light receiving element 61 is moved in the u direction or the v direction (FIG. 15) to acquire the angular distribution of the intensity of the scattered light from the portion to be measured (Step SC1). It is assumed that the angular distribution of the intensity of the scattered light is referred to as the first scattered light intensity distribution.

A procedure from Step SA5 to Step SA9 is the same as the procedure from Step SA5 to Step SA9 (FIG. 4) according to one embodiment. In one embodiment, in Step SA5, the provisional values of the root mean square roughness Sq and the surface correlation length Lc are determined. However, in another embodiment, the provisional values of the root mean square roughness Rq and the surface correlation length Lc in one dimension in the u direction or the v direction are determined. Therefore, in Step SA9, the values of the root mean square roughness Rq and the surface correlation length Lc are determined.

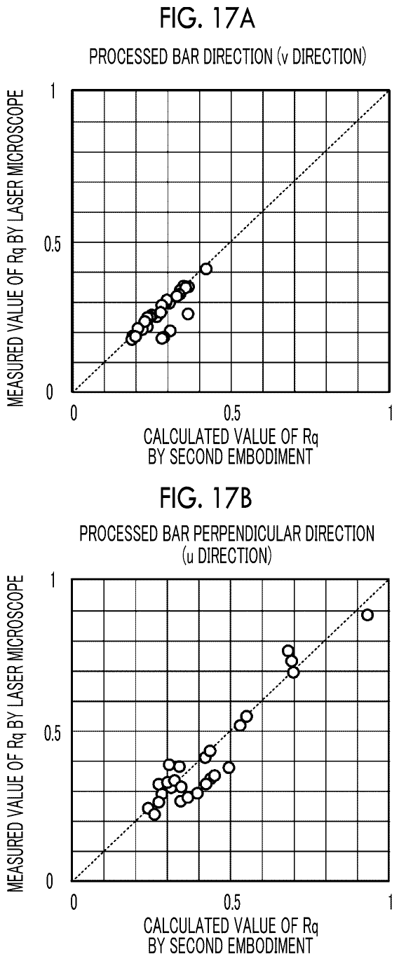

FIGS. 17A and 17B are scatter diagrams showing a relationship between the measured value of the root mean square roughness Rq by the laser microscope equipped with the white light interferometer according to the related art and the calculated value of the root mean square roughness Rq obtained by the calculation device according to another embodiment. A plurality of objects 30 were evaluated. The horizontal axis indicates the calculated value of the root mean square roughness Rq by another embodiment, and the vertical axis indicates the measured value of the root mean square roughness Rq by the laser microscope. FIGS. 17A and 17B show the root mean square roughness Rq of the side surface of the object 30 in a processed bar direction and a processed bar perpendicular direction, respectively.

It can be seen that the calculated value of the root mean square roughness Rq obtained by the surface roughness calculation device according to another embodiment is well matched with the measured value of the root mean square roughness Rq obtained by the laser microscope according to the related art. The evaluation results shown in FIGS. 17A and 17B proved that the root mean square roughness Rq could be calculated with sufficiently high accuracy by the surface roughness calculation device according to another embodiment.

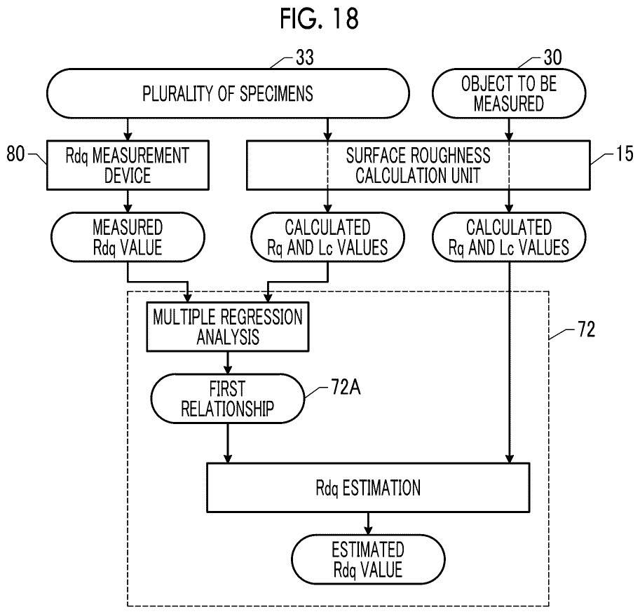

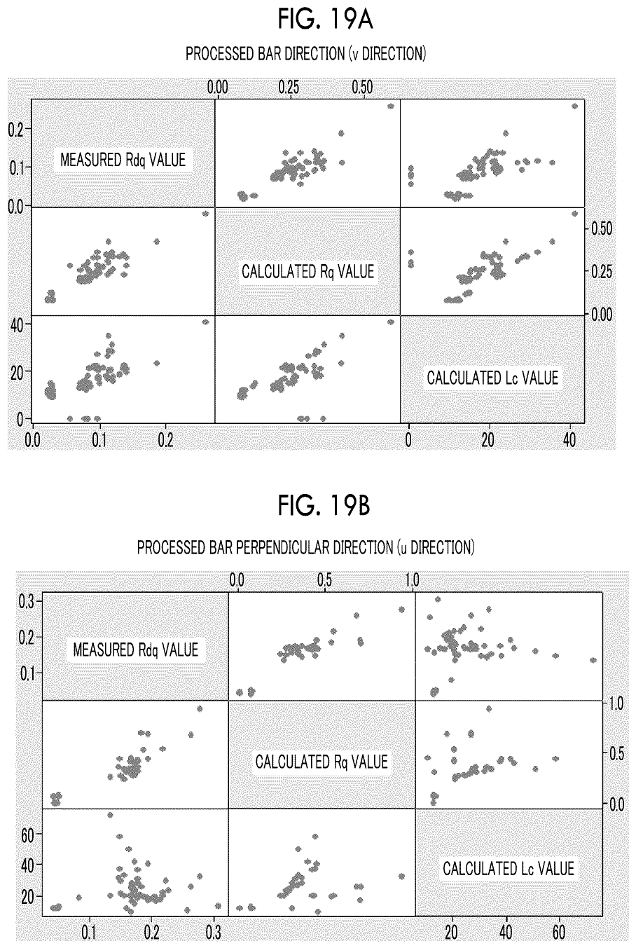

Next, the function of the root mean square slope estimation unit 72 will be described with reference to FIGS. 18 to 19B.

FIG. 18 is a block diagram showing the function of the root mean square slope estimation unit 72. The root mean square slopes Rdq of a plurality of specimens 33 are measured by a root mean square slope measurement device 80, and measured Rdq values are acquired. For example, the laser microscope can be used as the root mean square slope measurement device 80 according to the related art.

For the same plurality of specimens, the calculated values (a calculated Rq value and a calculated Lc value) of the root mean square roughness Rq and the surface correlation length Lc are acquired by the surface roughness calculation unit 15 of the surface roughness calculation device according to another embodiment. The root mean square slope estimation unit 72 performs multiple regression analysis using the calculated Rq value and the calculated Lc value as explanatory variables and the measured Rdq value as an objective variable.

FIGS. 19A and 19B are matrix scatter diagrams showing the measured Rdq value, the calculated Rq value, and the calculated Lc value. FIGS. 19A and 19B are the matrix scatter diagrams showing the surface roughness indexes in the processed bar direction (v direction) and the processed bar perpendicular direction (u direction), respectively. When the multiple regression analysis is performed based on the matrix scatter diagram, the following first relationship 72A (FIG. 18) is obtained for the processed bar direction and the processed bar perpendicular direction.

### Processed Bar Direction

$$\begin{matrix}[ Equation 10 ] & \\ Rqd = - 0.0138 + 0.3 \; 36 Rq + 0. 001 \; 07 Lc & ( 10 )\end{matrix}$$

### Processed Bar Perpendicular Direction

$$\begin{matrix}[ Equation 11 ] & \\ Rdq = 0.031 + 0.2 \; 66 Rq + 0. 000 \; 858 Lc & ( 11 )\end{matrix}$$

The determination coefficient R² of the first relationship 72A in the processed bar direction was 86.3%, and the determination coefficient R² of the first relationship 72A in the processed bar perpendicular direction was 88.6%.

The root mean square slope estimation unit 72 (FIG. 18) calculates the root mean square slope based on the first relationship 72A and the calculated Rq value and the calculated Lc value obtained by the surface roughness calculation unit 15 for the object 30, whose surface roughness is to be measured, to calculate an estimated Rdq value.

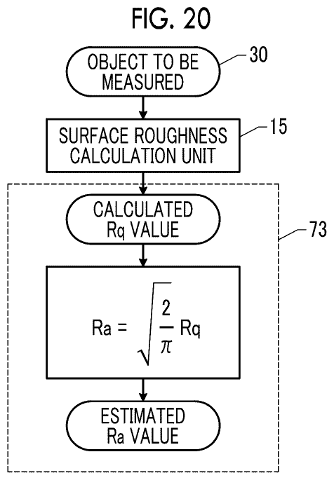

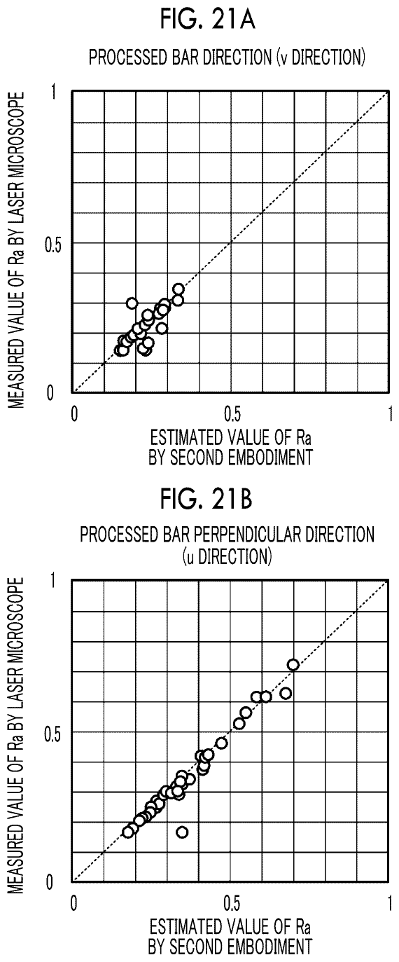

Next, the function of the arithmetic mean roughness estimation unit 73 will be described with reference to FIGS. 20 to 21B.

FIG. 20 is a block diagram showing the function of the arithmetic mean roughness estimation unit 73. The surface roughness calculation unit 15 obtains a calculated Rq value for the object 30 whose surface roughness is to be measured. Assuming that the deviation of the height from the mean of the height of the surface has a Gaussian distribution, an arithmetic mean roughness Ra and the root mean square roughness Rq have the following relationship.

$$\begin{matrix}[ Equation 12 ] & \\ Ra = \sqrt{\frac{2}{π}} Rq & ( 12 )\end{matrix}$$

When the calculated Rq value is obtained, the estimated value (estimated Ra value) of the arithmetic mean roughness Ra can be obtained by calculation using Equation (12). The arithmetic mean roughness estimation unit 73 calculates Ra from the calculated Rq value obtained by the surface roughness calculation unit 15 and Equation (12) to calculate the estimated Ra value.

FIGS. 21A and 21B are scatter diagrams showing a relationship between the estimated Ra value calculated using Equation (12) and the measured Ra value obtained by the laser microscope. The horizontal axis indicates the estimated value of Ra calculated by the surface roughness calculation device according to another embodiment, and the vertical axis indicates the measured Ra value obtained by the laser microscope. FIGS. 21A and 21B show the values of the arithmetic mean roughnesses Ra of the object 30 in the processed bar direction and the processed bar perpendicular direction, respectively.

It can be seen that the estimated value of Ra calculated by the surface roughness calculation device according to another embodiment is well matched with the measured Ra value obtained by the laser microscope. It was confirmed that the arithmetic mean roughness Ra could be estimated with sufficiently high accuracy by the surface roughness calculation device according to another embodiment.

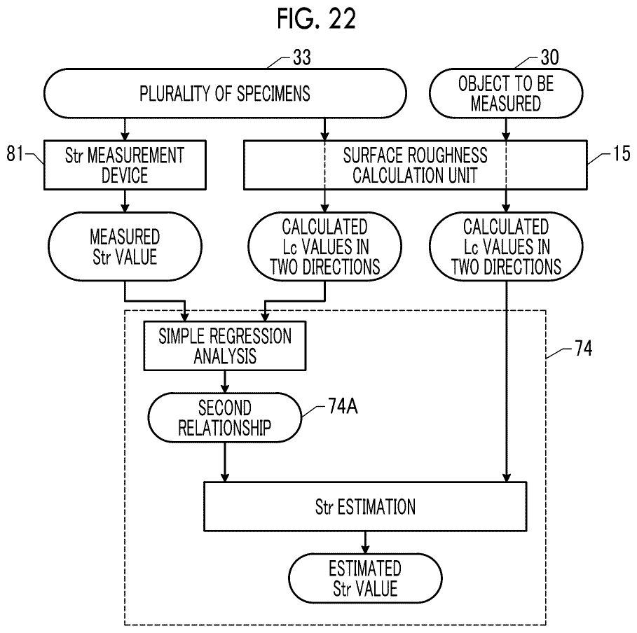

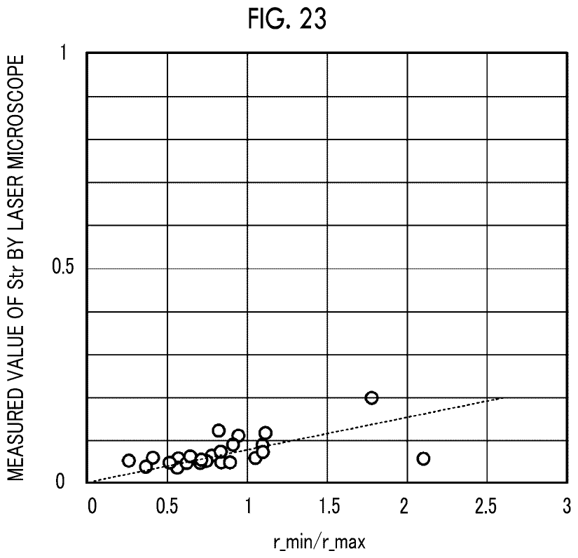

Next, the function of the surface property aspect ratio estimation unit 74 will be described with reference to FIGS. 22 and 23.

FIG. 22 is a block diagram showing the function of the surface property aspect ratio estimation unit 74. A surface property aspect ratio Str is measured for the plurality of specimens 33 by a surface property aspect ratio measurement device 81, and a measured Str value is acquired. For example, the laser microscope can be used as the surface property aspect ratio measurement device 81.

For the same plurality of specimens, the calculated values (calculated Lc values) of the surface correlation lengths Lc in two directions of the processed bar direction (v direction) and the processed bar perpendicular direction (u direction) (FIG. 15) are acquired by the surface roughness calculation unit 15 of the surface roughness calculation device according to another embodiment. The surface property aspect ratio estimation unit 74 performs simple regression analysis, using variables based on the calculated Lc values in the two directions as explanatory variables and the measured Str value as an objective variable.

Hereinafter, the explanatory variables of the simple regression analysis will be described. A surface shape autocorrelation function ACF is represented by the following equation using a moving distance as x.

$$\begin{matrix}[ Equation 13 ] & \\ ACF ( x ) = {e}^{- \frac{{x}^{2}}{L {c}^{2}}} & ( 13 )\end{matrix}$$

In general, when the correlation coefficient is equal to or less than 0.2, it is determined that there is almost no correlation. In a case where the moving distance x when the value of the autocorrelation function ACF is 0.2 is represented by r, the distance r is given by the following equation.

$$\begin{matrix}[ Equation 14 ] & \\ r = \sqrt{- 2 L {c}^{2} ln ( 0.2 )} & ( 14 )\end{matrix}$$

The surface correlation length in the processed bar direction (v direction) is represented by Lc_max, and the surface correlation length in the processed bar perpendicular direction (u direction) is represented by Lc_min. Variables r_max and r_min are defined by the following equation.

$$\begin{matrix}[ Equation 15 ] & \\ r\_max = \sqrt{- 2 {( Lc\_max )}^{2} ln ( 0.2 )} & ( 15 )\end{matrix}$$

$$r\_min = \sqrt{- 2 {( Lc\_min )}^{2} ln ( 0.2 )}$$

r_min/r_max is adopted as the explanatory variable of the simple regression analysis.

FIG. 23 is a scatter diagram showing a relationship between the variable r_min/r_max calculated from the calculated value of the surface correlation length Lc and the measured value of Str. It is assumed that this relationship is referred to as a second relationship 74A (FIG. 22). In FIG. 23, the horizontal axis indicates the variable r_min/r_max, and the vertical axis indicates the measured value of Str. It can be seen that there is a correlation between the two. The determination coefficient R² was 0.8413.

The surface property aspect ratio estimation unit 74 (FIG. 22) calculates the surface property aspect ratio Str based on the second relationship 74A and the calculated values of the surface correlation lengths Lc in the two directions obtained by the surface roughness calculation unit 15 for the object 30, whose surface roughness is to be measured, to calculate an estimated Str value.

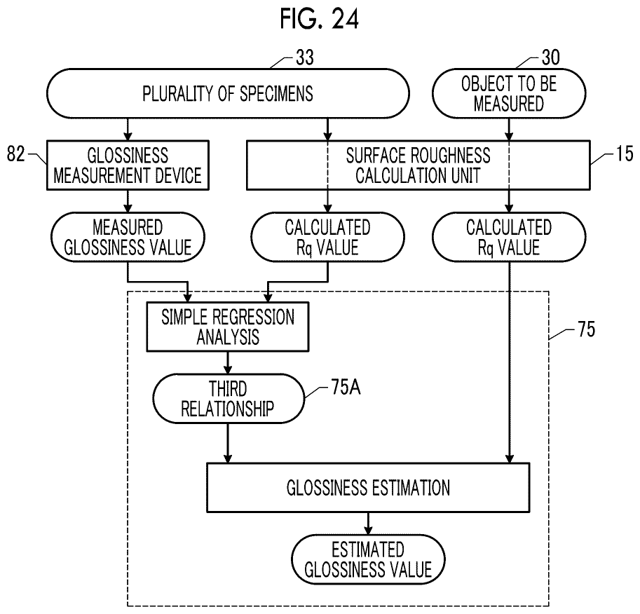

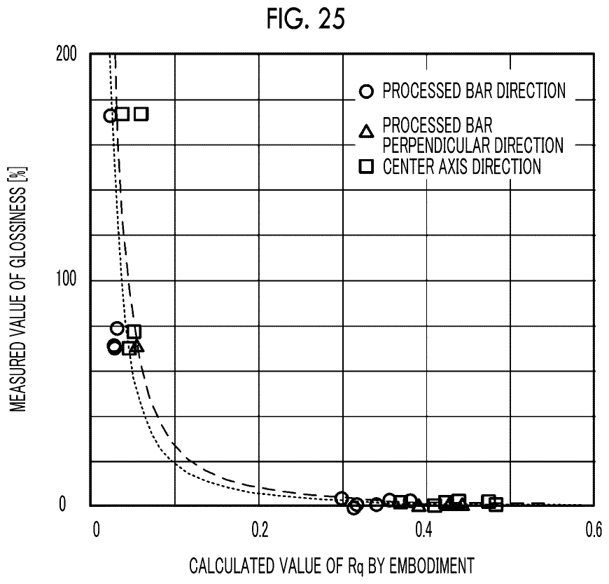

Next, the function of the glossiness estimation unit 75 (FIG. 14) will be described with reference to FIGS. 24 and 25.

FIG. 24 is a block diagram showing the function of the glossiness estimation unit 75. Glossiness is measured for a plurality of specimens 33 by a glossiness measurement device 82 according to the related art, and a measured glossiness value is acquired. In the measurement of the glossiness, the incident angle was set to 20°.

For the same plurality of specimens, the root mean square roughness Rq (calculated Rq value) is acquired by the surface roughness calculation unit 15 of the surface roughness calculation device according to another embodiment. The glossiness estimation unit 75 performs simple regression analysis in which the calculated Rq value is used as an explanatory variable and the measured glossiness value is used as an objective variable.

FIG. 25 is a scatter diagram showing a relationship between the calculated Rq value and the measured glossiness value. The horizontal axis indicates the calculated Rq value obtained by the surface roughness calculation unit 15 of the surface roughness calculation device according to another embodiment, and the vertical axis indicates the measured glossiness value. In the scatter diagram, a circle symbol indicates a value in the processed bar direction, a triangle symbol indicates a value in the processed bar perpendicular direction, and a square symbol indicates a value in the center axis direction of the specimen 33. The calculated Rq value in the center axis direction of the specimen 33 can be calculated using the first scattered light intensity distribution measured by changing the posture of the U-direction moving mechanism 62U (FIG. 15) such that the u direction is parallel to the xz plane in Step SC1 (FIG. 16).

In any direction of the specimen 33, a correlation was established between the calculated Rq value and the measured glossiness value. In the example shown in FIG. 25, when the measured value of the glossiness and the calculated Rq value in the processed bar direction are represented by Bv and Rqv, respectively, the measured value of the glossiness and the calculated Rq value in the processed bar perpendicular direction are represented by Bu and Rqu, respectively, and the measured value of the glossiness and the calculated Rq value in the center axis direction of the specimen 33 are represented by Ba and Rqa, respectively, these variables are represented by the following regression equation. In the following equation, the determination coefficient R² is shown together with each regression equation.

$$\begin{matrix}[ Equation 16 ] & \\ Bv = 0.4632 \times {Rqv}^{- 1.647} , {R}^{2} = 0 \text{.7036} & ( 16 )\end{matrix}$$

$$Bu = 0.6714 \times {Rqu}^{- 1.627} , {R}^{2} = 0 \text{.6966}$$

$$Ba = 0.6456 \times {Rqa}^{- 1.646} , {R}^{2} = 0.6 \; 801$$

It is assumed that the regression equation of Equation (16) is referred to as a third relationship 75A (FIG. 24). The glossiness estimation unit 75 (FIG. 24) estimates the glossiness of the object 30, whose glossiness is to be evaluated, based on the calculated Rq value obtained by the surface roughness calculation unit 15 and on the third relationship 75A and calculates an estimated glossiness value.

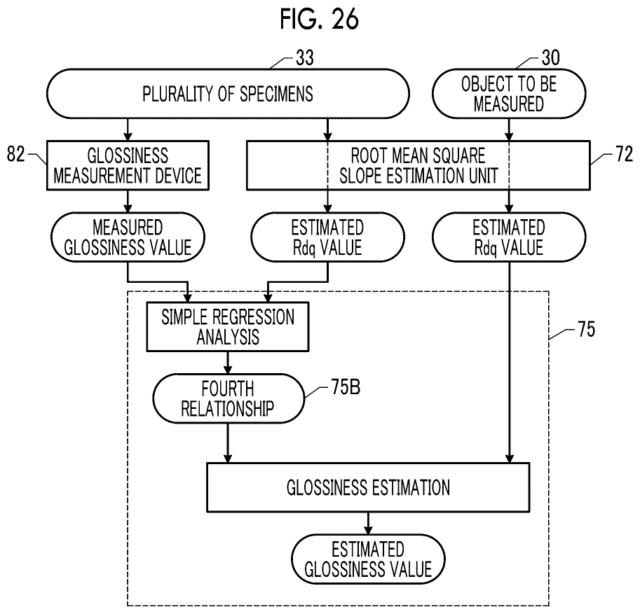

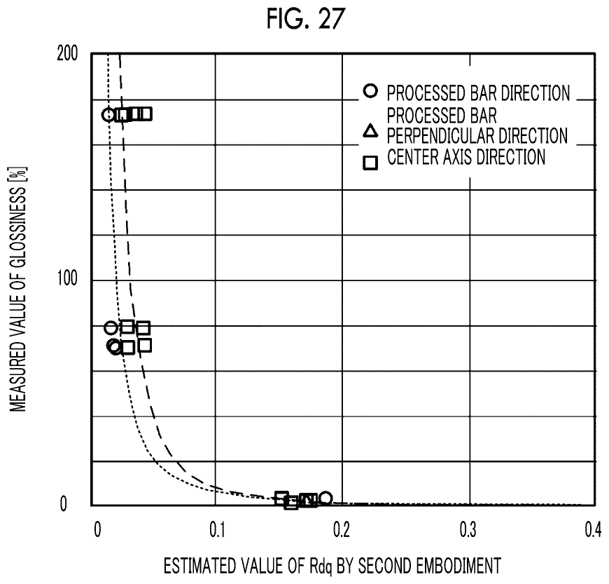

Next, another function of the glossiness estimation unit 75 (FIG. 14) will be described with reference to FIGS. 26 and 27.

FIG. 26 is a block diagram showing another function of the glossiness estimation unit 75. In the function shown in FIG. 24, the calculated Rq value is used as the explanatory variable of the simple regression analysis performed by the glossiness estimation unit 75. However, in the function shown in FIG. 26, the estimated Rdq value obtained by the root mean square slope estimation unit 72 is used as the explanatory variable of the simple regression analysis.

FIG. 27 is a scatter diagram showing a relationship between the estimated Rdq value and the measured glossiness value. The horizontal axis indicates the estimated Rdq value calculated by the root mean square slope estimation unit 72 of the surface roughness calculation device according to another embodiment, and the vertical axis indicates the measured glossiness value. In the scatter diagram, a circle symbol indicates a value in the processed bar direction, a triangle symbol indicates a value in the processed bar perpendicular direction, and a square symbol indicates a value in the center axis direction of the specimen 33.

In any direction of the specimen 33, a correlation was established between the estimated Rdq value and the measured glossiness value. In the example shown in FIG. 27, when the measured value of the glossiness and the estimated Rdq value in the processed bar direction are represented by Bv and Rdqv, respectively, the measured value of the glossiness and the estimated Rdq value in the processed bar perpendicular direction are represented by Bu and Rdqu, respectively, and the measured value of the glossiness and the estimated Rdq value in the center axis direction of the specimen 33 are represented by Ba and Rdqa, respectively, these variables are represented by the following regression equation. In the following equation, the determination coefficient R² is shown together with each regression equation.

$$\begin{matrix}[ Equation 17 ] & \\ Bv = 0.1198 \times {Rdqv}^{- 1.726} , {R}^{2} = 0 \text{.665} & ( 17 )\end{matrix}$$

$$Bu = 0.0464 \times {Rdqu}^{- 2.235} , {R}^{2} = 0 \text{.6431}$$

$$Ba = 0.0468 \times {Rdqa}^{- 2.221} , {R}^{2} = 0.6 \; 049$$

It is assumed that the regression equation of Equation (17) is referred to as a fourth relationship 75B (FIG. 26). The glossiness estimation unit 75 (FIG. 26) estimates the glossiness of the object 30, whose glossiness is to be evaluated, based on the estimated Rdq value calculated by the root mean square slope estimation unit 72 and on the fourth relationship 75B and calculates an estimated glossiness value.

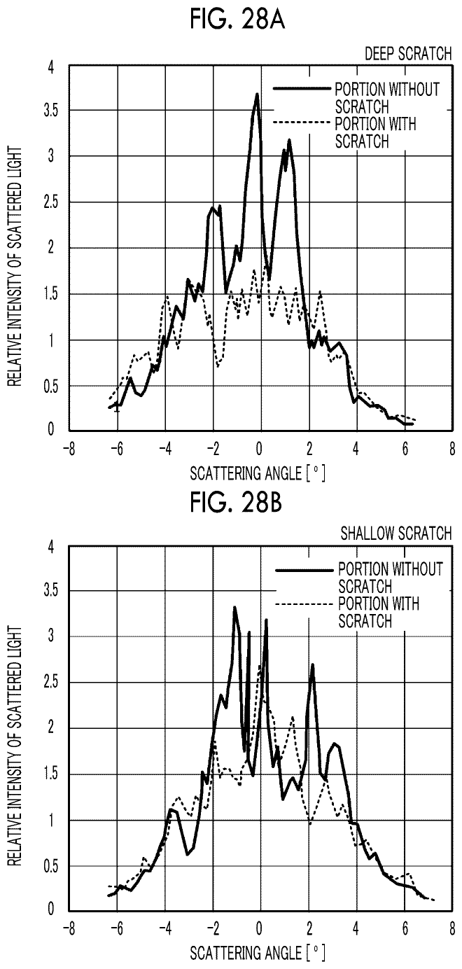

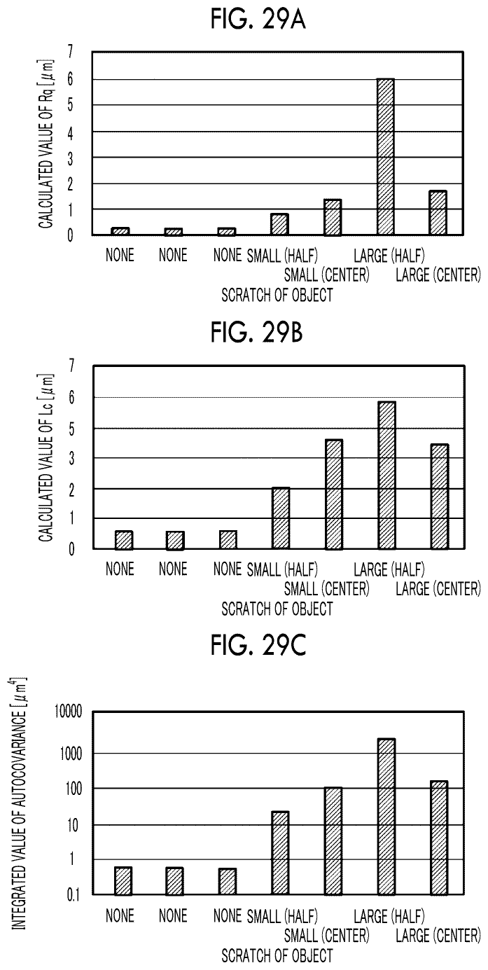

Next, the function of the scratch determination unit 76 (FIG. 14) will be described with reference to FIGS. 28A to 29C. FIGS. 28A and 28B are graphs showing the first scattered light intensity distribution acquired in Step SC1 (FIG. 16). The horizontal axis indicates a scattering angle in units of [°], and the vertical axis indicates the relative intensity of the scattered light. In FIGS. 28A and 28B, a solid line indicates the first scattered light intensity distribution obtained by the incidence of the laser beam on a portion without a scratch in the object 30 (FIG. 14), and a broken line indicates the first scattered light intensity distribution obtained by the incidence of the laser beam on a portion with a scratch in the object 30. The scratch formed in the object 30 from which the distribution shown in FIG. 28B has been obtained is shallower than the scratch formed in the object 30 from which the distribution shown in FIG. 28A has been obtained.

In both cases of FIGS. 28A and 28B, the maximum value of the intensity distribution of the scattered light from the portion with a scratch is smaller than the maximum value of the intensity distribution of the scattered light from the portion without a scratch. This is because the number of diffuse reflection components increases due to the scratch. As described above, the scattered light intensity distribution differs depending on the presence or absence of the scratch.

FIG. 29A is a graph showing the calculated values of Rq obtained when the laser beam is incident on a portion without a scratch, a portion with a relatively small scratch, and a portion with a relatively large scratch in the object 30 in units of [μm]. “NONE” on the horizontal axis means that the laser beam is incident on the portion without a scratch. “SMALL (HALF)” and “SMALL (CENTER)” mean a case where a shallow scratch passes through a peripheral portion of a beam spot and a case where a shallow scratch passes through a central portion of the beam spot, respectively. “LARGE (HALF)” and “LARGE (CENTER)” on the horizontal axis mean a case where a deep scratch passes through the peripheral portion of the beam spot and a case where a deep scratch passes through the central portion of the beam spot, respectively.

It can be seen that the calculated Rq value obtained in the portion with a scratch is larger than the calculated Rq value obtained in the portion without a scratch. Therefore, the calculated Rq value is a useful index in determining whether a scratch is present or absent. For example, an appropriate determination threshold value can be set, and it is possible to determine whether a scratch is present or absent based on a comparison result between the calculated Rq value and the determination threshold value. For example, when the calculated Rq value is larger than the determination threshold value, it may be determined that a scratch is present.

FIG. 29B is a graph obtained by changing the vertical axis of the graph shown in FIG. 29A to the surface correlation length Lc. In FIG. 29B, the vertical axis indicates the calculated value of the surface correlation length Lc in units of [μm]. It can be seen that the calculated Lc value obtained in the portion with a scratch is larger than the calculated Lc value obtained in the portion without a scratch. Therefore, the calculated Lc value is a useful index in determining whether a scratch is present or absent. For example, an appropriate determination threshold value can be set, and it is possible to determine whether a scratch is present or absent based on a comparison result between the calculated Lc value and the determination threshold value. For example, when the calculated Lc value is larger than the determination threshold value, it may be determined that a scratch is present.

FIG. 29C is a graph obtained by changing the vertical axis of the graph shown in FIG. 29A to an integrated value of the autocovariance of the scattered light intensity distribution. In FIG. 29B, the vertical axis indicates the integrated value of the autocovariance in units of [μm⁴]. It can be seen that the integrated value of the autocovariance calculated in the portion with a scratch is larger than the integrated value of the autocovariance calculated in the portion without a scratch. Therefore, the integrated value of the autocovariance is a useful index in determining whether a scratch is present or absent. For example, an appropriate determination threshold value can be set, and it is possible to determine whether a scratch is present or absent based on a comparison result between the integrated value of the autocovariance and the determination threshold value. For example, when the integrated value of the autocovariance is larger than the determination threshold value, it may be determined that a scratch is present.

Next, an excellent effect of another embodiment will be described.

In another embodiment, it is possible to calculate the surface roughness without using the Ward BRDF model as in one embodiment. Therefore, it is possible to suppress a reduction in calculation accuracy caused by using the Ward BRDF model.

In another embodiment, it is possible to obtain information related to the surface roughness of the object without using a complex optical system such as a light field camera.

Next, modification examples of another embodiment will be described.

In another embodiment, the light receiving element 61 is moved in the u direction, the v direction (FIG. 15), and the like to measure the intensity distribution of the scattered light. However, a light receiving device, such as a CMOS camera, capable of measuring a two-dimensional light intensity distribution may be used instead of the light receiving element 61. In this case, it is possible to acquire the intensity distribution of the scattered light without moving the CMOS camera or the like.

In addition, the light field camera 20 used in one embodiment may be used instead of the light receiving element 61. Only one line of an area sensor can be used to operate the light field camera 20 as a line sensor. When the light field camera 20 is operated as the line sensor, it is possible to calculate the calculated value or estimated value of the surface roughness index related to line roughness as in another embodiment.

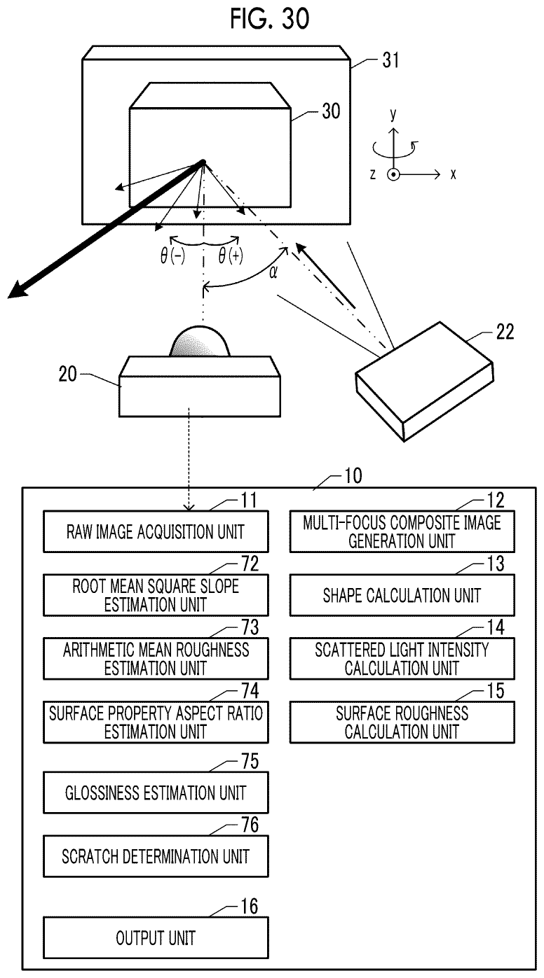

Next, a surface roughness calculation device according to further embodiment will be described with reference to FIGS. 30 to 34. Hereinafter, a description of configurations common to the surface roughness calculation devices according to one embodiment (FIGS. 1 to 13D) and another embodiment (FIGS. 14 to 29C) will be omitted.

FIG. 30 is a schematic view showing a surface roughness measurement apparatus including the surface roughness calculation device according to further embodiment. In another embodiment, the measurement portion includes the laser source 60, the light receiving element 61, and the light receiving element moving mechanism 62. However, in further embodiment, the measurement portion includes the projector 22 and the light field camera 20 as in one embodiment. In addition, in further embodiment, the root mean square slope estimation unit 72, the arithmetic mean roughness estimation unit 73, the surface property aspect ratio estimation unit 74, the glossiness estimation unit 75, and the scratch determination unit 76 are added to the surface roughness calculation device 10 (FIG. 1) according to one embodiment.

The surface property aspect ratio estimation unit 74 calculates the estimated Str value using the calculated Lc values in two directions similarly to the surface property aspect ratio estimation unit 74 (FIG. 22) according to another embodiment. In further embodiment, since the light field camera 20 is used as the light receiving device, it is possible to obtain the calculated Lc values in the two directions. A calculated Lc value in a direction in which the surface correlation length Lc is maximized and a calculated Lc value in a direction in which the surface correlation length Lc is minimized may be used as the calculated Lc values in the two directions.

The scratch determination unit 76 determines whether a scratch is present or absent using the same method as the determination method of the scratch determination unit 76 according to another embodiment described with reference to FIGS. 28A to 29C.

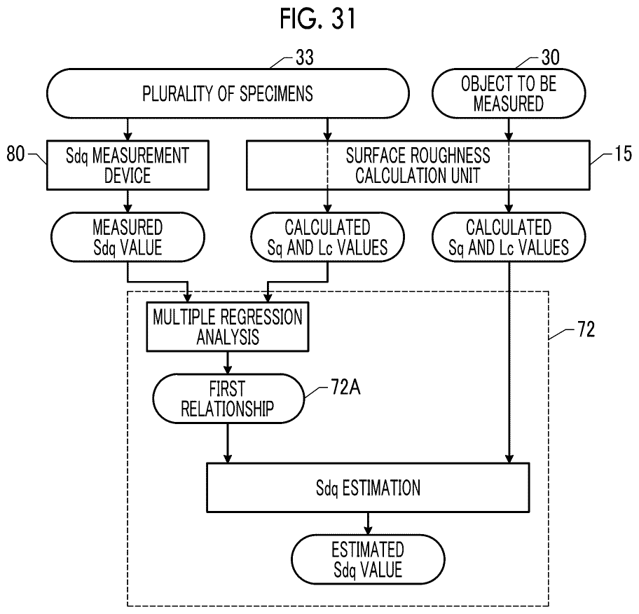

FIG. 31 is a block diagram showing the function of the root mean square slope estimation unit 72. In FIG. 18, the measured Rdq value related to the line roughness of the plurality of specimens 33 is calculated by the root mean square slope measurement device 80. However, in further embodiment, a measured Sdq value related to the surface roughness of the plurality of specimens 33 is calculated by the root mean square slope measurement device 80. In addition, the surface roughness calculation unit 15 obtains the calculated Sq values and the calculated Lc values related to the surface roughnesses of the plurality of specimens 33 and the object 30 whose surface roughness is to be evaluated.

The root mean square slope estimation unit 72 performs multiple regression analysis, using the calculated Sq values and the calculated Lc values of the plurality of specimens 33 as explanatory variables and the measured Sdq value as an objective variable, to obtain the first relationship 72A. The root mean square slope Sdq is estimated based on the calculated Sq value and the calculated Lc value of the object 30 and the first relationship 72A, and an estimated Sdq value is calculated.

In addition, the light field camera 20 can be used as a line sensor in a pseudo manner by using only one line of the area sensor of the light field camera 20. The use of the light field camera 20 as the line sensor makes it possible to calculate the estimated Rdq value as shown in FIG. 18.

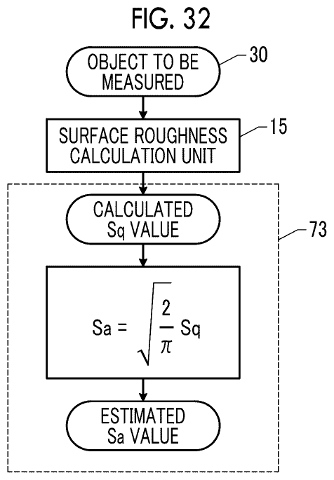

FIG. 32 is a block diagram showing the function of the arithmetic mean roughness estimation unit 73. In FIG. 20, the estimated Ra value is calculated from the calculated Rq value related to the line roughness calculated by the surface roughness calculation unit 15. However, in further embodiment, an estimated Sa value is calculated from the calculated Sq value related to the surface roughness calculated by the surface roughness calculation unit 15.

In addition, the use of the light field camera 20 as the line sensor makes it possible to calculate the estimated Ra value as in the case shown in FIG. 20.

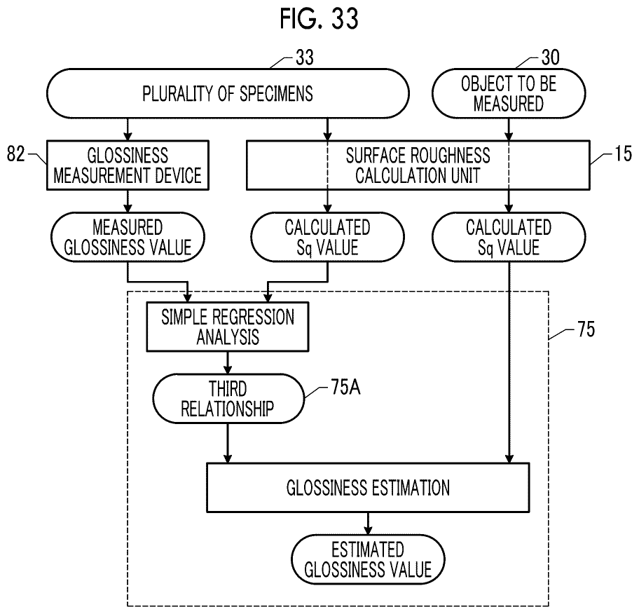

FIG. 33 is a block diagram showing the function of the glossiness estimation unit 75. In FIG. 24, the calculated Rq value related to the line roughness is obtained by the surface roughness calculation unit 15. However, in further embodiment, the calculated Sq value related to the surface roughness is obtained.

The glossiness estimation unit 75 performs simple regression analysis, using the calculated Sq values of the plurality of specimens 33 as explanatory variables and the measured glossiness value as an objective variable, to obtain the third relationship 75A. The glossiness is estimated based on the calculated Sq value of the object 30 and the third relationship 75A, and an estimated glossiness value is calculated.

In addition, the use of the light field camera 20 as the line sensor makes it possible to obtain the calculated Rq value related to the line roughness using the same method as the method shown in FIG. 4. Further, it is possible to calculate the estimated glossiness value using the calculated Rq value as in the case shown in FIG. 24.

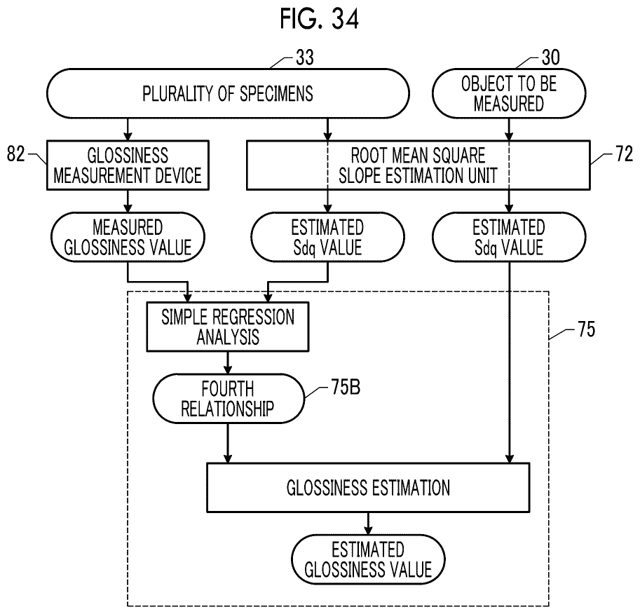

FIG. 34 is a block diagram showing another function of the glossiness estimation unit 75. In FIG. 26, the root mean square slope estimation unit 72 calculates the estimated Rdq value related to the line roughness. However, in further embodiment, the estimated Sdq value related to the surface roughness is calculated. The glossiness estimation unit 75 performs simple regression analysis, using the estimated Sdq values of the plurality of specimens 33 as explanatory variables and the measured glossiness value as an objective variable, to obtain the fourth relationship 75B. The glossiness is estimated based on the estimated Sdq value of the object 30 and the fourth relationship 75B, and the estimated glossiness value is calculated.

In addition, the use of the light field camera 20 as the line sensor makes it possible to calculate the estimated glossiness value, using the estimated Rdq value, as in the case shown in FIG. 26.

The above-described embodiments and modification examples are illustrative, and it goes without saying that the configurations described in the embodiments and the modification examples can be partially replaced or combined. The same operation and effect by the same configurations according to the embodiments and the modification examples will not be repeatedly described in each of the embodiments and the modification examples. Further, the present invention is not limited to the above-described embodiments and modification examples. For example, it will be apparent to those skilled in the art that various modifications, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A surface roughness calculation device comprising:
a scattered light intensity distribution acquisition unit that receives scattered light from a surface of an object and that calculates a first scattered light intensity distribution from a light reception result; and
a surface roughness calculation unit that calculates a surface roughness index of the object,
wherein the surface roughness calculation unit corrects a provisional value of the surface roughness index until a second scattered light intensity distribution obtained by calculation using the provisional value of the surface roughness index and the first scattered light intensity distribution satisfy a first fitting condition, and
determines the provisional value of the surface roughness index when the first fitting condition is satisfied as a value of the surface roughness index of the surface of the object.

2. The surface roughness calculation device according to claim 1, further comprising:
a raw image acquisition unit that acquires a raw image captured by a light field camera; and
an output unit.

3. The surface roughness calculation device according to claim 2,
wherein the surface roughness calculation unit outputs a result of the calculated surface roughness index to the output unit.

4. The surface roughness calculation device according to claim 1,
wherein the scattered light intensity distribution acquisition unit includes:
a multi-focus composite image generation unit that combines a plurality of single-focus images generated from a raw image obtained by imaging the surface of the object with a light field camera to generate a multi-focus composite image;
a shape calculation unit that applies a spatial coding method or a phase shift method to the multi-focus composite image to calculate shape information of the surface of the object; and
a scattered light intensity calculation unit that calculates the first scattered light intensity distribution based on a light field obtained from the raw image obtained by the light field camera.

5. The surface roughness calculation device according to claim 4,
wherein the multi-focus composite image generation unit generates the multi-focus composite image for each of a plurality of raw images obtained by projecting a plurality of different patterns onto the object, and
the shape calculation unit applies the spatial coding method to a plurality of the multi-focus composite images to calculate the shape information of the surface of the object.

6. The surface roughness calculation device according to claim 4,
wherein the multi-focus composite image generation unit generates the multi-focus composite image for a raw image obtained by projecting one pattern onto the object, and
the shape calculation unit applies the phase shift method to the multi-focus composite image to calculate the shape information of the surface of the object.

7. The surface roughness calculation device according to claim 4,
wherein the scattered light intensity calculation unit calculates the first scattered light intensity distribution of the surface of the object based on a light field calculated from a raw image obtained by imaging the surface of the object uniformly irradiated with monochromatic light using the light field camera.

8. The surface roughness calculation device according to claim 1,
wherein the scattered light intensity distribution acquisition unit acquires, as the first scattered light intensity distribution, a measurement result of an angular distribution of intensity of scattered light from an incident position when a laser beam is incident on the surface of the object.

9. The surface roughness calculation device according to claim 8,
wherein the surface roughness calculation unit uses provisional values of a root mean square roughness Rq and a surface correlation length Lc as the provisional value of the surface roughness index, and
determines the provisional values of the root mean square roughness Rq and the surface correlation length Lc when the first fitting condition is satisfied as the value of the surface roughness index of the surface of the object.

10. The surface roughness calculation device according to claim 9, further comprising:
a root mean square slope estimation unit,
wherein the root mean square slope estimation unit stores a first relationship among the root mean square roughness Rq, the surface correlation length Lc, and a root mean square slope Rdq calculated from values of the root mean square roughnesses Rq and the surface correlation lengths Lc calculated for a plurality of specimens by the surface roughness calculation unit and values of the root mean square slopes Rdq measured for the plurality of specimens, and
estimates a root mean square slope Rdq of the object from the first relationship and values of the root mean square roughness Rq and the surface correlation length Lc calculated for the object by the surface roughness calculation unit.

11. The surface roughness calculation device according to claim 10,
wherein the root mean square slope estimation unit performs multiple regression analysis in which the calculated value of the Rq and the calculated value of the Lc are used as explanatory variables and the measured value of the Rdq is used as an objective variable.

12. The surface roughness calculation device according to claim 9, further comprising:
an arithmetic mean roughness estimation unit that multiplies the value of the root mean square roughness Rq calculated for the object by the surface roughness calculation unit by (2/π)^{1/2} to estimate an arithmetic mean roughness Ra.

13. The surface roughness calculation device according to claim 9, further comprising:
a surface property aspect ratio estimation unit,
wherein the surface property aspect ratio estimation unit stores a second relationship between values of the surface correlation lengths Le in two directions perpendicular to each other and a value of a surface property aspect ratio Str calculated from the values of the surface correlation lengths Lc in the two directions perpendicular to each other, which have been calculated for a plurality of specimens by the surface roughness calculation unit, and the values of the surface property aspect ratios Str measured for the plurality of specimens, and
estimates a surface property aspect ratio Str of the object from the second relationship and values of the surface correlation lengths Lc in the two directions perpendicular to each other which have been calculated for the object by the surface roughness calculation unit.

14. The surface roughness calculation device according to claim 9, further comprising:
a glossiness estimation unit,
wherein the glossiness estimation unit stores a third relationship between values of the root mean square roughnesses Rq calculated for a plurality of specimens by the surface roughness calculation unit and values of glossinesses measured for the plurality of specimens, and
estimates a glossiness of the object from the third relationship and a value of the root mean square roughness Rq calculated for the object by the surface roughness calculation unit.

15. The surface roughness calculation device according to claim 10, further comprising:
a glossiness estimation unit,
wherein the glossiness estimation unit stores a fourth relationship between values of the root mean square slopes Rdq estimated for the plurality of specimens by the root mean square slope estimation unit and values of glossinesses measured for the plurality of specimens, and
estimates a glossiness of the object from the fourth relationship and a value of the root mean square slope Rdq estimated for the object by the root mean square slope estimation unit.

16. The surface roughness calculation device according to claim 15,
wherein the glossiness estimation unit performs simple regression analysis in which the calculated value of the Rq is used as an explanatory variable and the measured value of the glossiness is used as an objective variable.

17. The surface roughness calculation device according to claim 9, further comprising:
a scratch determination unit,
wherein the scratch determination unit compares at least one of a value of the root mean square roughness Rq and a value of the surface correlation length Lc determined by the surface roughness calculation unit and an integrated value of a surface shape autocovariance calculated from the values of the root mean square roughness Rq and the surface correlation length Lc with a determination threshold value, and determines whether a scratch is present or absent based on a comparison result.
